(19) United States
(12) Patent Application Publication
(10) Pub. No.: US 2009/0138433 A1
(43) Pub. Date: May 28, 2009

(54) Data Aggregation Systems And Methods

(75) Inventor: Wilbur Reid, Marietta, GA (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: S.P. Richards Company, Smyrna, GA (US)

(21) Appl. No.: 12/323,211

(22) Filed: Nov. 25, 2008

Related U.S. Application Data
(60) Provisional application No. 60/990,177, filed on Nov. 26, 2007.

(51) Int. Cl. G06F 17/30

(52) U.S. Cl. 707/2; 707/E17.131

(57) ABSTRACT

Data aggregation systems and methods capable of processing data related to a plurality of subscribers. In an exemplary embodiment, thee data aggregation system includes a receipt system, a sever assembly, a user interface, and a data analysis system. The receipt system can enable the data aggregation system to receive data, such as sales data, from the subscribers. Such data can be aggregated and stored on the server assembly. The user interface can be an element of a website serviced by the server assembly. Through the user interface, a subscriber can pose a request. In response to the request, the data analysis system can process a portion of the aggregated data and can, thereby produce a result set. The result set can be presented to the subscriber via the user interface.

### CROSS-REFERENCES TO RELATED APPLICATIONS

This application claims a benefit, under 35 U.S.C. § 119(e), of U.S. Provisional Application Ser. No. 60/990,177, filed 26 Nov. 2007, the entire contents and substance of which are hereby incorporated by reference.

### BACKGROUND OF THE INVENTION

1. Field of the Invention

The present invention relates to data aggregation systems and methods and, more particularly, to data aggregation systems and methods for aggregating and analyzing data from multiple sources.

2. Description of Related Art

In some industries, merchants generally prefer to maintain a constant margin for each offered product or service. As big discounters and other large inventory warehouse stores enter a market, however, merchants of small stores in the market react by reducing their otherwise flat margins to compete with discounters. As a result, merchants experience significantly reduced profit margins. Even with reduced margins, merchants' prices are too high on high velocity merchandise to adequately compete with prices of discounters, which settle for very low margins on high velocity merchandise and recover margin on low velocity merchandise.

In recent years, trade journals have theorized that the public is highly sensitive to prices of a limited number of highly visible products. According to this theory, members of the public know the prices of these particular products found at discounters. If other merchants fail to match the known prices, the merchants may be subject to poor price image. As a result, merchants sometimes attempt to guess which products are among those to which the public is highly sensitive. Trade journals also discuss a philosophy that gross profit margins should decline as prices increase. These journals, however, do not elaborate on how to accomplish this on a typical inventory of, for example, 15,000 products.

Conventional stock pricing systems fail to incorporate teachings of the above theory and philosophy, and further fail to enable merchants an efficient automated system for updating their prices. Many conventional pricing systems, for example, provide little more than an electronic filing cabinet for storing prices of products offered by merchants. Conventional pricing systems fail to integrate mathematics and logic into pricing schemes. As a result conventional pricing systems do not consider causes for certain prices, and do not determine pricing based on market factors.

Additionally, conventional pricing systems do not enable merchants to take significant control over their pricing. With these systems, merchants can generally only set a price for each offered product individually. Accordingly, merchants may spend significant time guessing appropriate market prices, and then individually updating each price within the pricing system. Performing these tasks for every product in inventory may become unmanageable for merchants.

Therefore, there is a need for a data aggregation system for aggregating sales data and automating calculation of retail market prices and sales strategies. There is a further need in the art for a data aggregation system capable of determining prices based on logical relationships between current prices and customers' purchasing decisions. It is to such a system that the present invention is directed.

### BRIEF SUMMARY OF THE INVENTION

Briefly described, aspects of the present invention comprise data aggregation systems and methods enabling dealers and merchants to more efficiently price their products, improve their pricing and margins, analyze their sales and sales strategies, compare their sales and sales strategies to those of the market, or perform various combinations of these tasks. Embodiments of the data aggregation system can generally comprise a receipt system, a server assembly, a user interface, and a data analysis system.

The receipt system can receive sales data from a plurality of subscribers, and can insert such data into a database of aggregated sales data stored on the server assembly. Preferably, the subscribers do not all belong to a single company or organizational entity. Two or more of the subscribers can be distinct entities that are independent from one another.

The server assembly can comprise one or more servers for supporting the website. Through the receipt system, the server assembly can be adapted to receive sales data periodically received from subscribers. Such sales data can be aggregated together on one or more databases stored on the server assembly.

The user interface can provide subscribers access to aspects of the aggregated sales data. The user interface can, but need not, be a user interface of a website. Through the user interface, a subscriber can request analysis of data stored on the server assembly. Such analysis can include comparisons of the subscriber's sales data to other sales data stored on the server assembly. The subscriber can utilize the user interface of the website to view and analyze the subscriber's pricing and sales strategies in various manners. For example, the subscriber can: analyze sales data of other subscribers, and use such sales data to make informed decisions regarding stocking and pricing; receive bid assistance for responding to bid requests of customers; and automatically update pricing based on a history of sales data and based on relationships between products.

The data analysis system can perform analyses of the data stored on, or accessible to, the server assembly. Results of such analyses can be output to subscribers via the user interface. The data analysis system can utilize various data analysis tools, such as a peer grouping module and a SKU mapping module. These data analysis tools can utilize aggregated data stored on the server assembly.

The peer grouping module of the data aggregation system can utilize the aggregated data to determine peer groups of customers of the subscribers. Each peer group can include customers of similar industry, size, and geographic region. Through peer grouping, analyses of sales strategies for a particular customer of a subscriber can be properly limited to data relating to a set of similar other customers.

The SKU mapping module of the data aggregation system can provide and retain sets of relationships between products stored on the server assembly. These relationships can be utilized to determine relationships between sales strategies of related products.

These and other objects, features, and advantages of the present invention will become more apparent upon reading the following specification in conjunction with the accompanying drawings.

### BRIEF DESCRIPTION OF THE FIGURES

FIG. 1 illustrates an architecture of a client computer accessing a data aggregation system, in accordance with an exemplary embodiment of the present invention.

FIG. 2 illustrates an architecture of a server assembly of the data aggregation system, according to an exemplary embodiment of the present invention.

FIG. 3 illustrates a block diagram of a receipt system of the data aggregation system, according to an exemplary embodiment of the present invention.

FIG. 4 illustrates a block diagram of a data analysis system of the data aggregation system, according to an exemplary embodiment of the present invention.

FIG. 5 illustrates a method of receiving and responding to a subscriber request in the data aggregation system, according to an exemplary embodiment of the present invention.

FIG. 6 illustrates a bid assistance output of the data aggregation system, according to an exemplary embodiment of the present invention.

FIG. 7 illustrates another bid assistance output of the data aggregation system, according to an exemplary embodiment of the present invention.

FIGS. 8A-8B illustrate a profitability analysis output of the data aggregation system, according to an exemplary embodiment of the present invention.

FIG. 9 illustrates a customer details output of the data aggregation system, according to an exemplary embodiment of the present invention.

FIGS. 10A-B illustrate a customer price index comparison output of the data aggregation system, according to an exemplary embodiment of the present invention.

FIGS. 11A-B illustrate an exemplary output of the data aggregation system in response to a subscriber's request to compare the subscriber's pricing to market pricing, according to an exemplary embodiment of the present invention.

FIG. 12 illustrates another exemplary output of the data aggregation system in response to a subscriber's request to compare the subscriber's pricing to market pricing, according to an exemplary embodiment of the present invention.

FIG. 13 illustrates an exemplary depiction of sales trends output by the data aggregation system, according to an exemplary embodiment of the present invention

FIG. 14 illustrates an exemplary comparison of a subscriber's sales to market sales, according to an exemplary embodiment of the present invention

FIG. 15 illustrates a chart depicting sales to customers in predetermined regions, according to an exemplary embodiment of the present invention.

FIG. 16 illustrates a scatter plot of sales to customers, according to an exemplary embodiment of the present invention.

FIG. 17 illustrates a table depicting upsell opportunities, according to an exemplary embodiment of the present invention.

FIG. 18 illustrates a table depicting results of a SKU mapping module of the data aggregation system, according to an exemplary embodiment of the present invention.

FIG. 19 illustrates a scatter plot of pricing for a particular product, according to an exemplary embodiment of the present invention.

FIG. 20 illustrates an analysis report depicting gross profits, according to an exemplary embodiment of the present invention.

FIG. 21 illustrates a waterfall chart representing pricing, according to an exemplary embodiment of the present invention.

FIG. 22 illustrates a chart suggesting a new pricing strategy, according to an exemplary embodiment of the present invention.

### DETAILED DESCRIPTION OF PREFERRED EMBODIMENTS

To facilitate an understanding of the principles and features of the present invention, various illustrative embodiments are explained below. In particular, the invention is described in the context of being a data aggregation system and method for aggregating and analyzing sales data. Embodiments of the invention, however, are not limited to analysis of sales data. Rather, embodiments of the invention can be used to analyze various types of data, such as, for example, data relating to employment, credit histories, or inventory stocking levels.

The components described hereinafter as making up various elements of the invention are intended to be illustrative and not restrictive. Many suitable components that would perform the same or similar functions as components described herein are intended to be embraced within the scope of the data aggregation system. Such other components not described herein can include, but are not limited to, for example, components developed after development of the invention.

Various embodiments of the present invention comprise data aggregation systems and methods. Referring now to the figures, wherein like reference numerals represent like parts throughout the views, various embodiments of the data aggregation system and method will be described in detail.

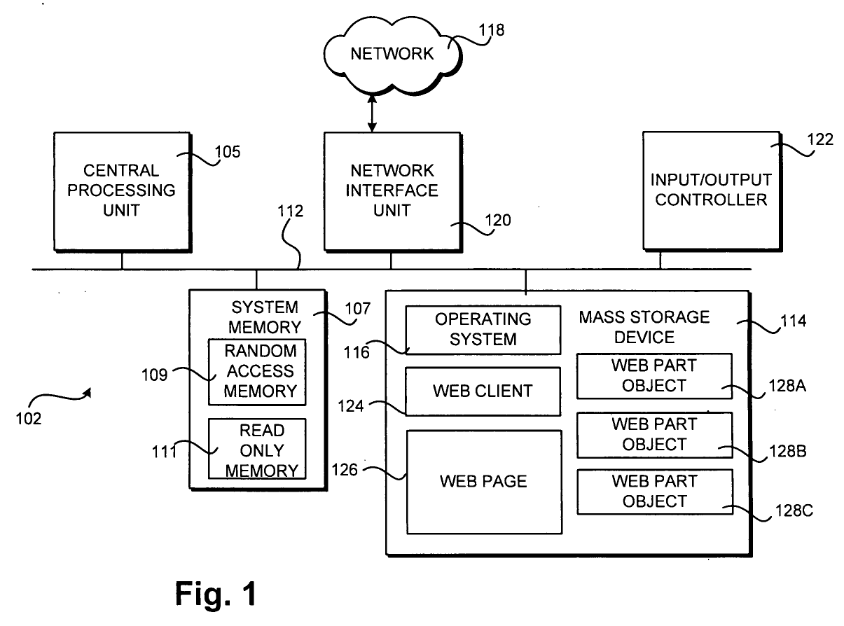

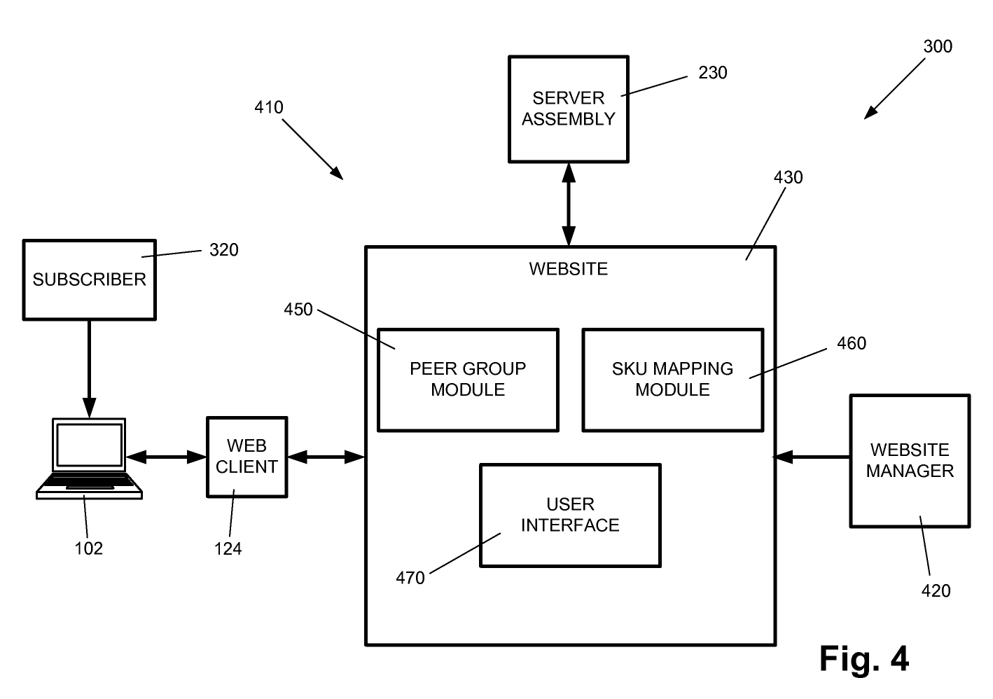

FIG. 1 illustrates a computer architecture for a client computer 102, in accordance with an exemplary embodiment of the present invention. The client computer 102 may be used to access the website 430 (FIG. 4). Those skilled in the art will recognize that the general architecture described in reference to FIG. 1 is for example only, and may be modified to accommodate various embodiments of the data aggregation system and particular operational environments. As shown in FIG. 1, the client computer 102 may comprise a central processing unit 105 (“CPU”) and one or more system memories 107, such as a random access memory 109 (“RAM”) and a non-volatile memory, such as a read-only memory (“ROM”) 111. The client computer 102 may further comprise a system bus 112 coupling together the memory 107, the CPU 5, and various other components. A basic input/output system containing routines to assist in transferring information between components of the client computer 102 may be stored in the ROM 111.

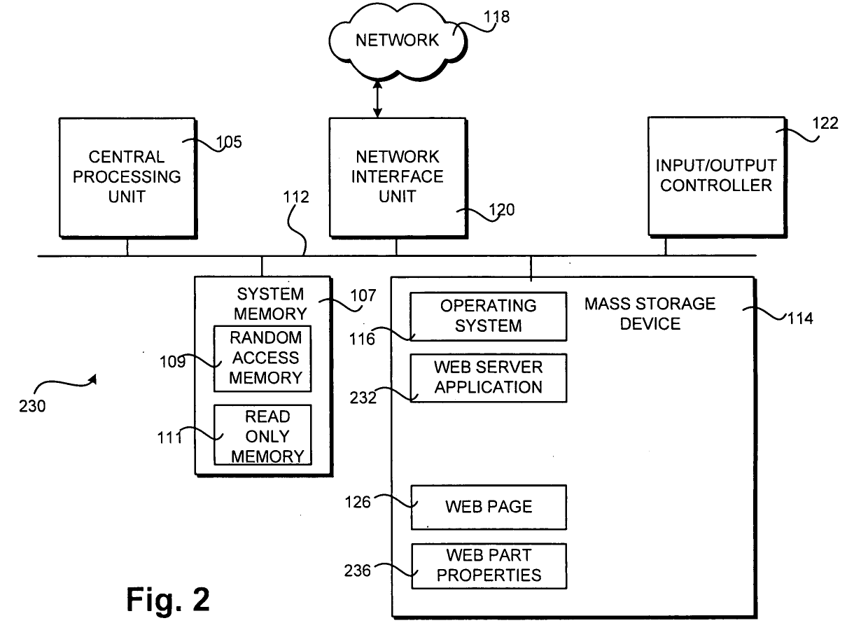

The client computer can comprise or can be associated with various forms of computer-readable media. One such form of computer-readable media can be embodied in a mass storage device 114. Although the description of computer-readable media contained herein generally refers to a mass storage device, such as a hard disk or CD-ROM drive, it will be appreciated by those skilled in the art that computer-readable media may include many available media accessible by the client computer 102 or a server assembly 230 (FIG. 2). The mass storage device 114 can store an operating system 116, application programs, and other program modules. The mass storage device 114 can be connected to the CPU 105 through a mass storage controller (not shown) connected to the bus 112. The mass storage device 114 can provide non-volatile storage for the client computer 102.

Computer-readable media can include computer storage media, such as volatile and non-volatile, removable and non-removable media implemented in many methods or technologies for storage of information, such as computer-readable instructions, data structures, program modules, or other data. Computer storage media can include, but is not limited to, RAM, ROM, EPROM, EEPROM, flash memory, other solid state memory technology, CD-ROM, digital versatile disks (“DVD”), other optical storage, magnetic cassettes, magnetic tape, magnetic disk storage, other magnetic storage devices, or many other media that may be used to store the desired data and may be accessible by the client computer 102 or the server assembly 230. Computer-readable instructions on the storage media of the client computer 102 may include, for example, instructions for implementing processes, preferably client-side processes, of the data aggregation system 300.

According to various embodiments, the client computer 102 may operate in a networked environment using logical connections to remote computers, such as the server assembly 230, through a network 118, such as the Internet. The client computer 102 may connect to the network 118 through a network interface unit 120 connected to the bus 112. It will be appreciated that the network interface unit 120 may also be utilized to connect to other types of networks and remote computer systems.

The client computer 102 may also include an input/output controller 122 for receiving and processing input from a number of other devices, including a keyboard, mouse, or electronic stylus. The input/output controller 122 may provide output to a display screen, a printer, or other type of output device.

A number of program modules and data files may be stored in the mass storage device 114 and RAM 109 of the client computer 102. Such program modules and data files may also include an operating system 116 suitable for controlling operations of a networked personal computer. A web browser application program, or web client 124, may also be stored on the mass storage device 114 and the RAM 109. The web client 124 may comprise an application program for requesting and rendering web pages 126 created in Hypertext Markup Language (“HTML”) or other types of markup languages. The web client 124 may also be capable of executing scripts through the use of a scripting host. The scripting host executes program code expressed as scripts within the browser environment.

The web client 124 may be operative to execute one or more client side objects. Client side objects are executable objects that may be identified in a web page 126 and executed in conjunction with the rendering of the web page 126. For instance, JAVA® applets or ACTIVEX® controls may be identified on a web page 126 and rendered by the web client 124 to generate a portion of the display of the web page 126.

According to an exemplary embodiment of the invention, the web client 124 may be further operative to utilize client side objects called web part objects 128A-128C, or web parts. Web part objects 128A-128C are reusable client side objects that stand and contain web-based content such as Extensible Markup Language (“XML”), HTML, and scripts. Web parts 128A-128C have a set of standard properties that control how they are rendered. These properties enable web parts to be storage-neutral and reusable. Because web parts 128A-128C adhere to a common standard, they may be stored in libraries, which may be utilized to create a variety of web pages 126. Web pages 126 that include web part objects 128A-128C may be referred to herein as web part pages.

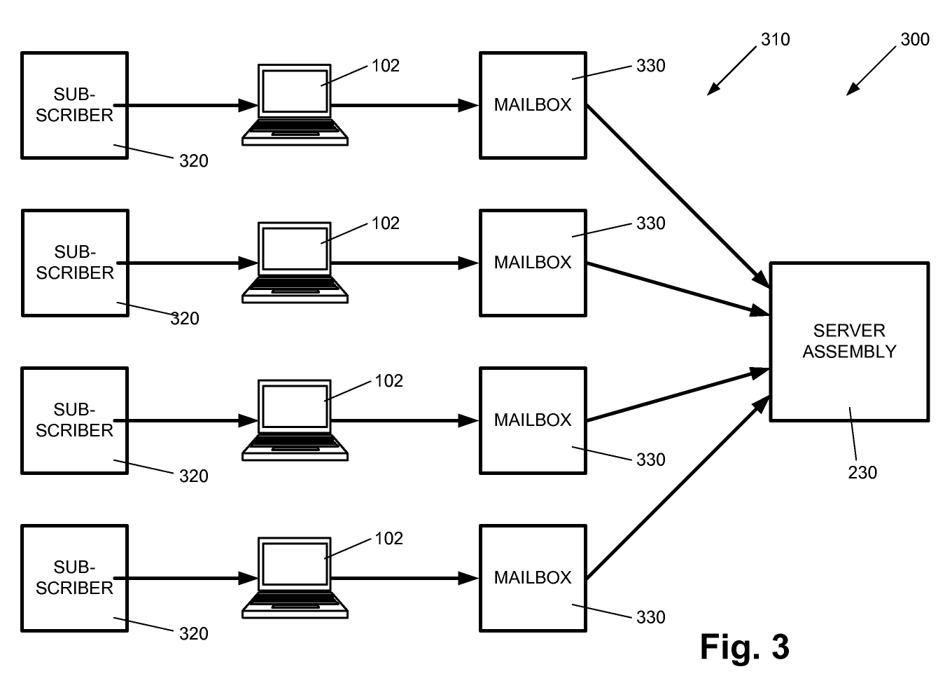

Referring now to FIG. 2, a server assembly 230 utilized in various exemplary embodiments of the data aggregation system 300 (FIGS. 3-4) is illustrated. The server assembly 230 may service the website 430 by receiving and responding to requests from web clients 124. The server assembly 230 may comprise various combinations of hardware and software for servicing the website 430. Those skilled in the art will recognize that the server assembly 230 described in FIG. 2 is an exemplary server configuration and may be modified to accommodate various embodiments of the data aggregation system 300. As shown in FIG. 2, the server assembly 230 may include many of the conventional computing components included in the client computer 102 and described above with respect to FIG. 1. In particular, the server assembly 230 can include a CPU 105, a network interface unit 120 connected to a network 118, such as the Internet, a system memory 107, and a mass storage device 114.

The mass storage device 114 utilized by the server assembly 230 may typically be operative to store an operating system 116 suitable for servicing the website 430 and controlling operations of a server computer. The mass storage device 114 and its associated computer-readable storage media provide non-volatile storage for the server assembly 230. Computer storage media may include volatile and non-volatile, removable and non-removable media implemented in many methods or technologies for storage of information, such as computer-readable instructions, data structures, program modules, or other data. Computer-readable instructions on the computer-readable media of the server assembly 230 may include, for example, instructions for implementing processes, preferably server-side processes, of the data aggregation system 300.

The server assembly 230 may utilize a web server application 232. The web server application 232 may receive and respond to requests from web clients 124 at remote computers, such as the client computer 102, for web pages 126 located at or accessible to the server assembly 230. It will be appreciated that web pages 126, as described herein, include both those pages stored statically and utilizing only HTML, as well as pages generated dynamically through use of server-side scripting technologies.

According to various embodiments of the data aggregation system 300, the web server application 232 may receive requests for web pages 126 that include one or more web parts 128A-128C. As discussed above, web parts 128A-128C can comprise client-side objects that may be used by the web client 124 when displaying a web page 126.

FIGS. 3-4 illustrate block diagrams of portions of the data aggregation system 300, according to an exemplary embodiment of the present invention. As shown, the data aggregation system 300 can comprise a receipt system 310 (FIG. 3) and a data analysis system 410 (FIG. 4).

### Receipt System

As shown in FIG. 3, the receipt system comprises a means for subscribers 320 to submit data to the data aggregation system 300. In an exemplary embodiment of the data aggregation system 300, a subscriber 320 can be a dealer or merchant, and the data submitted to the data aggregation system 300 can comprise data relating to sales made by the subscriber. Each subscriber can also submit standard price lists for the subscriber's products, as well as price lists containing prices extended to particular customers or groups of customers.

The receipt system 320 can receive and accept data from the subscribers 320. By receiving sales data from multiple subscribers 320, the data aggregation system 300 can aggregate sales data and can analyze sales data of individual subscribers 320 as well as groups of subscribers 320. The receipt system 310 can enable storage of such data in one or more databases on, or accessible to, the server assembly 230.

As shown in FIG. 3, a subscriber 320 can have one or more mailboxes 330 for transmitting data to the server assembly 230 of the data aggregation system 300. Preferably, to prevent a first subscriber's direct access to data of a second subscriber 320, each mailbox 330 can be dedicated to no more than a single subscriber 320. Alternatively, however, subscribers 320 having relationships of trust can share a mailbox 330, and subscribers 320 not requiring confidentiality can share a mailbox 330.

A subscriber 320 can transmit data through the receipt system 310 by various manners and over various types of networks. For example, and not limitation, data can be transmitted over the Internet, Bluetooth network, wired local area network (“LAN”), wireless LAN, or a combination thereof. Preferably, the mailboxes 330 utilize a file transfer process (“FTP”) or file transfer process secure (“FTPS”) protocol.

Periodically, a subscriber 320 can deposit data into a prespecified mailbox 330. Such deposits can occur once per day, multiple times per day, once per week, or at another interval deemed appropriate. Preferably, each deposit includes data generated since the last deposit, and generated data corresponds to sales made since the last deposit and, if applicable, pricing updates.

Additionally, it can be desirable for the data aggregation system 300 to retain a history of data for one or more subscribers 320, including subscribers 320 that are newly subscribed to the data aggregation system 300. Accordingly, on a one-time basis, a subscriber 320 can transmit through the receipt system 310 a history of data representing a period of time prior to when the subscriber 320 first transmitted data to the receipt system 310. For example, during a first transmission, the subscriber 320 can transmit data for the previous or current day as well as data for a three-year period, or other duration, prior to the previous or current day. As a result, the data aggregation system 300 can receive and retain a history of data for some or all subscribers 320.

Data submitted by the subscriber 320 can describe sales made by the subscriber 320. Such sales can represent either a subset of the subscriber's sales or can represent all of the subscriber's sales.

Various data relating to a subscriber's sales can be submitted to the data aggregation system 300 via the receipt system 310. The following fields represent an example of data that can be submitted for each sale of the subscriber 320:

| Exemplary Variable Name | Description |
|---|---|
| dealer_id | A unique identifier for the subscriber submitting the sales data |
| order_id | Order ID for this particular transaction. This can be an invoice |
| | number. Together, the order_id and the order_line_id field below |
| | can make each row unique. |
| order_line_id | Order line ID for this transaction. When a sale contains multiple |
| | SKUs, a different order line ID can be used for each SKU in the |
| | order. |
| dealer_native_prod_id | Product ID as ordered by subscriber. |
| master_cust_id | Identifies the parent or master account associated to the customer |
| | ID or customer number below. If there is no parent or master |
| | account, the same value as the customer id or number can be |
| | used. |
| cust_id | Unique ID of the customer purchasing products or services. |
| datetimestamp | Invoice date and, optionally, time for the specific transaction. |
| invoice_price | Price extended to the customer after application of discounts. |
| Cogs | Cost of goods sold. |
| Quantity | Quantity shipped |
| base_price | Original price of the SKU sold before discounts. |
| Cost | Total cost for this line, including cogs and other costs. This may be |
| | the sum of the cost elements below if you have that detailed cost |
| | information. If detailed cost information is not available, this field |
| | will equal cogs. |
| | Other cost fields are: Commissions (23) + Freight (24) + Payment |
| | Terms (26) + Rebates (27) + Other (28) + Overhead (29) − Freight |
| | Allowance (25). |
| Discount | Discount applied to the transaction. This is a calculated field that is |
| | base price less invoice price. |
| cust_name | Customer name |
| sic_code | US government standard code indicating the customer's primary |
| | business. |
| postal_code | Postal code of the ship-to location of customer (if ship-to location is |
| | not available, default to bill-to location). If US postal code send |
| | only the first 5 digits. Not the full 9 digit postal code. |
| dealer_native_prod_desc | Product name as seen by Dealer. |
| UOM | Unit of measure code indicating an amount of the SKU |
| | represented by a single quantity. |
| prod_group | Identifies a group that the product belongs. |
| Master Customer Name | The name of the master customer for the master customer id. |

Additionally, optional fields relating to each sale can include the following:

| | |
|---|---|
| prod_id | Product ID in the supplier's records. |
| source_id | Source of the product (i.e., From where did the subscriber |
| | purchase the product?). |
| sales_person_id | ID of a person securing the sale |
| order_type | Identifies how the consumer placed the order (e.g., over the |
| | Internet). |
| commissions | Commission cost applied to the sale |
| Freight | Freight cost applied to the sale |
| freight allowance | Identifies the discount off freight or other charges |
| payment_terms | Estimated cost of the payment terms to the subscriber (e.g., cost |
| | of holding a receivables account for the sale). |
| Rebates | Rebate cost applied to the sale |
| Other | Other costs applied to the sale |
| overhead | Overhead cost applied to the sale |
| num_wht_collar_employees | Number of White Collar Employees at the customer site |
| spr_prod_name | Descriptive name of SPR product, matching spr_prod_id |
| prod_stocked | Identifies whether the product is stocked or not stocked. |
| sales_person_name | Sales person name |
| Sales_territory_name | Identifies a territory for the sales person |
| mgr_sales_person_name | Manager for sales person |

One skilled in the art will recognize that many combinations of the above fields, along with various other fields, can be included as sales data for each sale. Further, included fields need not be consistent across multiple sales.

If the subscriber 320 wishes to conceal certain data, for example, to respect confidentiality of a customer, fields can be removed or generalized. In an exemplary embodiment of the receipt system 310, raw data can be submitted to describe each sale individually. Alternatively, the subscriber's data can be generalized or cleansed at, for examples, the dealer level or the market level. Dealer-level cleansed data can exclude fields identifying individual customers, such that the data is summarized at the dealer level. Market-level cleansed data can additionally exclude fields identifying the dealer, or subscriber 320, such that data is summarized at the market level. Sales data for multiple sales can be combined into a single row if, after removing identifying data, various included fields are similar across such sales.

For efficient parsing, transmitted data can be submitted in a predefined format. For example, and not limitation, the data can be submitted in a text or spreadsheet format. If submitted in a text format, each line of a submission can represent a distinct sale by the subscriber 320 and can terminate with a return character, slash, pipe, or other predetermined delimiter. Various organizations of data can be implemented within a text file submitted through the receipt system 300, so long as the organization is parseable by the data aggregation system 300. For example, variables in the submitted data can appear in the text file in a predetermined order or, alternatively, a variable field name for each variable can immediately precede, or follow, a corresponding value for the variable.

To effect aggregation of data, sales data from the subscribers 320 can be retrieved from the mailboxes 330 and combined in one a database on the server assembly 230. Preferably, retrieving data from the mailboxes 330 occurs via an automated process occurring periodically. Data retrieval, however, can also occur manually by an entity involved in operations of the data aggregation system 300. As discussed in detail below, the database can be queried as necessary to analyze the aggregated data.

As an alternative to the mailbox format described above, data can be manually submitted via a website 430 (FIG. 4) of the data aggregation system 300. For example, each subscriber 320 can occasionally log into the website 430 and can specify a data file for upload to the server assembly 230. Such data can relate to sales of the subscriber 320 as described above.

FIG. 4 illustrates a block diagram of the data analysis system 410 of the data aggregation system 300, according to an exemplary embodiment of the present invention. As shown in FIG. 4, the data analysis system 410 can comprise the server assembly 230, a website manager 420, and a website 430.

The server assembly 230 can service the website 430. The server assembly 230 can operate as discussed in detail above, or in various manners for providing services to client computers 102 over a network.

The website manager 420 can manage the website 430, act as administrator of the website 430, and provide customer service to users of the website 430. Preferably, the website manager 420 can be one or more humans or entities, but can also comprise computing devices and automated services.

Each subscriber can access the website 430 through a client computer 102 utilizing a web client 124. Generally, the website 430 can enable subscribers 320 to manage their prices and inventory, as well as analyze their sales and sales strategies and compare such sales and sales strategies to those of a market. The website 430 can comprise a user interface 470 accessible to subscribers 320, and can utilize a peer grouping module 450 and a SKU mapping module 460.

### Peer Grouping Module

The peer grouping module 450 can utilize the aggregated data in the database to determine peer groups of customers. A peer group can contain customers of similar industry, size, geographic region, or many combinations thereof and of other factors. For purposes of establishing peer groups, a geographic region can include a location as well as a population density, such as rural, urban, or suburban.

To establish peer groups, the peer grouping module 450 can consider customer attributes, such as SIC codes, zip codes, number of white collar employees, and various other factors relevant to identifying groups of customers that might behave similarly in their purchase decisions. One reasonably skilled in art would recognize that various combinations of factors can be considered in determining a peer group. These customer attributes can be received by the data aggregation system 300 via the receipt system 310, as described in detail above.

In determining relevant benchmarks for establishing appropriate pricing and margin expectations relating to a customer, it can be important that similar types of customers be used in reports and analyses. For example, a large attorneys' office in a city will likely have different price sensitivities than a small attorneys' office in a rural area. Accordingly, peer groups can be determined and stored in the database to enable proper analyses of subscribers' interactions with customers.

### SKU Mapping Module

The data aggregation system 300 can further comprise a SKU mapping module 460 for mapping relationships between stock-keeping units (“SKU”). Generally, a SKU uniquely identifies a product or service within a subscriber's inventory. The SKU mapping module 460 can define relationships between SKUs. In an exemplary embodiment of the data aggregation system 300, the SKU mapping module is editable by the website manager 420.

As discussed above, in conventional pricing systems, subscribers 320 update pricing for each product, or SKU, individually. If a subscriber 320 desires to update pricing for a group of related SKUs, the subscriber will generally update each SKU record individually. Further, in conventional systems, the subscriber 320 must manually identify related SKUs to assist in repricing. Such manual identification can be time-consuming and can lead to critical human errors. Further, conventional pricing systems are inefficient in that each individual subscriber 320 may identify the same or similar relationship among their products, and accordingly, subscribers 320 repeat work performed by other subscribers 320.

To alleviate the above problems, the SKU mapping module 460 can map relationships between and among subscribers' SKUs. To provide the SKU mapping module, the website manager 420 can, manually or otherwise, identify such relationships. Knowledge of these relationships can then be passed along to subscribers 320. Accordingly, the SKU mapping module 460 can provide a valuable service to the subscribers 320 by eliminating a need to repeat work performed by others.

The SKU mapping module 460 can include, without limitation, the following services: create relationships between substitute products, create relationships between complementary products, create relationships between products within a family, create relationships between competitive products, and modify predefined relationships.

A substitute product can be defined as a product that a subscriber's customer might be willing to accept instead of a given product. Substitute product relationships can generally be bi-directional. In other words, when product A is deemed a substitute for product B, product B is likely deemed a substitute for product A.

The substitute product can be classified according to its quality as compared to the given product. The substitute product can be an equivalent substitute, a superior substitute, or an inferior substitute. Generally, when customer cost is the same for the given product and its substitute, a customer will prefer a superior substitute over the given product, will prefer the given product over an inferior product, and may be indifferent between the given product and an equivalent substitute. For example, a first black, one-inch, round-ring binder can be deemed a substitute for a second black, one-inch, round-ring binder. However, if the second binder includes additional features, such as a one-touch opener or extra pockets, then the second binder can be a superior substitute for the first binder. While the binders can be substituted for each other, the second binder can present an upsell opportunity compared to the first binder.

Additionally, units of measure can be considered when identifying substitute products. Units of measure can be relevant when, for example, products are similar but packaged differently. For example, a subscriber 320 can stock AA batteries packaged in 4-packs, 8-packs, and 12-packs. If a customer requests a 24-pack, which the subscriber 320 does not retain in stock, the SKU mapping module can recognize that the 24-pack is equivalent to two 12-packs. The data aggregation system 300 can then suggest the substitution via the user interface 470.

A complementary product can complement, or improve or enhance use of, a given product. For example, an ink cartridge designed for a particular printer can complement such printer. Similar to substitute product relationships, complementary product relationships can also be bi-directional. While the ink cartridge complements the printer, likewise, the printer complements the ink cartridge.

A first product can be in a same family as a second product when the first and second products are often sold at the same discount. For example, two newly released DVDs of different movies can be in the same family.

A competitive product can be a substitute product in competition with the given product. Two products can be in competition if, for example, they come from different manufacturers or different suppliers. In an exemplary embodiment of the data aggregation system 300, if the website manager 420 is associated with a product supplier, the website manager 420 can benefit by identifying competitive products. Then, the website manager 420 can recommend its own products over products of competitors.

The SKU mapping module can utilize a database on the server assembly 230. The database can store one or more records for each SKU. In the database, a SKU can be associated with a product description and references to relationships between the SKU and related other SKUs.

The website manager 420 can manually identify product relationships or can automate a process of identifying such relationships. In an exemplary embodiment of the data aggregation system 300, when a new SKU is inserted into the database 430, relationships can be automatically formed between the new SKU and potentially related SKUs. Automatically formed relationships can be based on predetermined rules set by the website manager 420 or by a developer of the data aggregation system 300.

For example, when a newly released DVD is inserted into the database, a family relationship can automatically be formed between the inserted DVD and other newly released DVDs in the database. For further example, a complementary relationship can automatically form between an ink cartridge of particular manufacturer and a printer of the same manufacturer. Preferably, the website manager 420 can confirm such automatic relationships to ensure that they are appropriately assigned.

A subscriber 320 can take advantage of the SKU mapping module 460 by utilizing the user interface 470. Further, in an exemplary embodiment, the subscriber 320 can view identified SKU-mapped relationships on the website 430. The website 430 can allow the subscriber 320 to alter such relationships via the user interface 470, thereby producing personalized SKU relationships. Personalized relationships can be stored on the server assembly 230 along with reference to the subscriber's account on the website 430. Accordingly, when the subscriber 320 logs into the website 430, the subscriber's personalized relationships can be viewed and utilized in analyses and comparisons instead of standard SKU-mapped relationships used by subscribers 320 without personalized relationships.

When a subscriber 320 updates a record for a particular SKU, the subscriber 320 can be notified of relationships between the updated SKU and other SKUs in the database. Alternatively, the record for related SKUs can be automatically updated when appropriate. For example, a discount can be applied to a family of SKUs, so when a single SKU in a family is discounted, the discount can automatically apply to other SKUs in the family.

Additionally, if a SKU is relevant to a particular analysis performed by a subscriber 320 through the user interface 470, related SKUs can automatically be considered in the analysis as well. This aspect of the data aggregation system 300 will be described in greater detail below.

### User Interface

The user interface 470 can enable subscribers 340 to manage prices of products and services offered for sale, to analyze their sales and sales strategies, and to compare their sales and sales strategies to those of a market. More specifically, the user interface 470 can enable subscribers 340 to perform various tasks, including, without limitation: creating and modifying pricing for their products; providing automated pricing updates; receiving notifications of issues and opportunities, such as upsell opportunities, based on aggregated sales data and subscribers' current pricing; receiving bid assistance; and comparing subscribers' pricing and selling strategies compared to other merchants in the market.

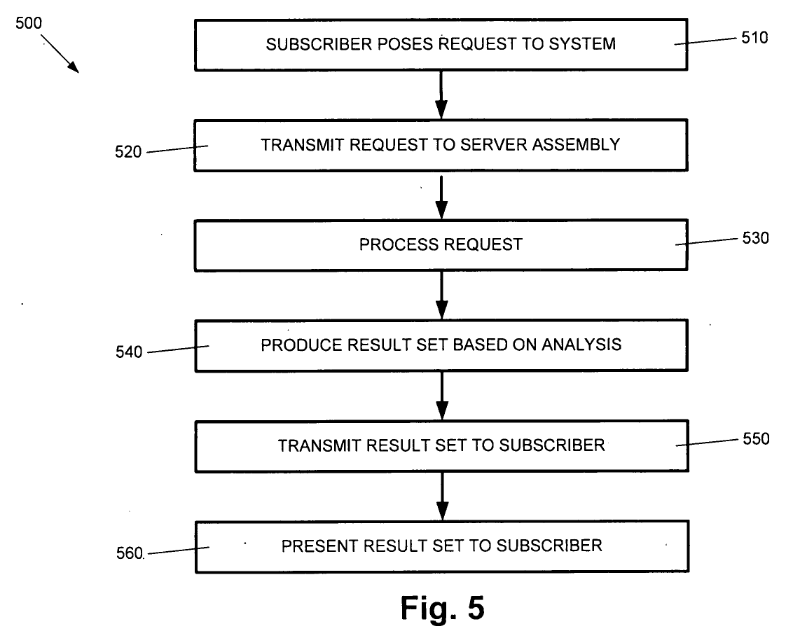

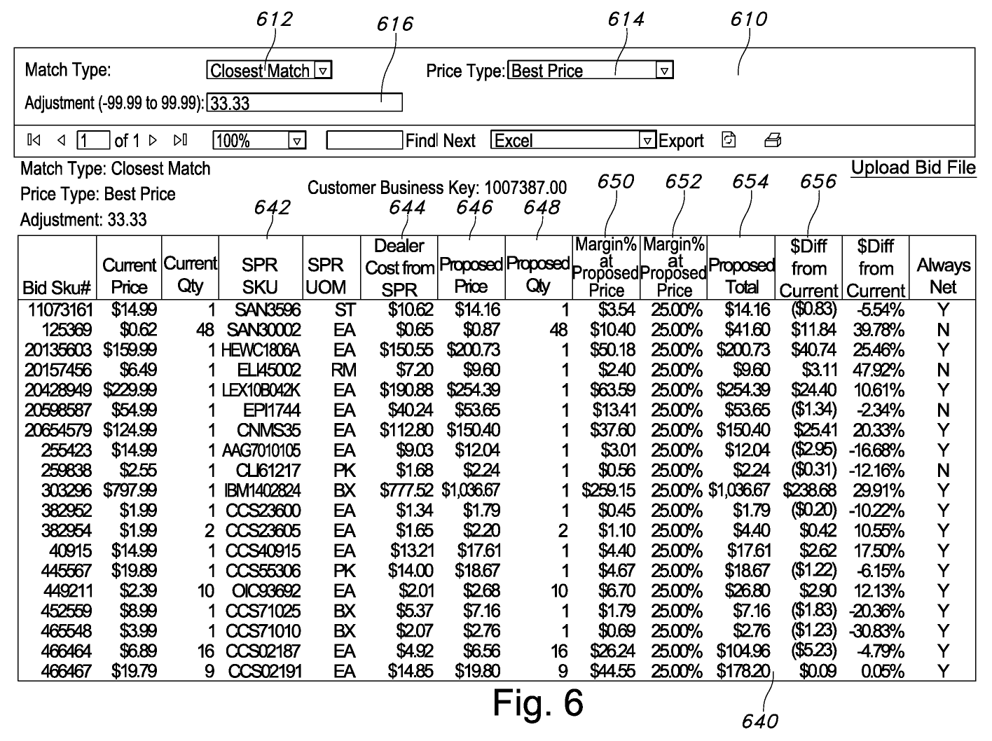

In general, subscribers 320 can pose requests to the data aggregation system 300 via the user interface 470 of the website 430. FIG. 5 illustrates a method 500 of handling a subscriber's request to the data aggregation system 300. At 510, the subscriber poses the request. The request can generally take the form of the subscriber's clicking a link or a button on the user interface 470 of the website 430, or the subscriber 320 can select an option from a menu or manually type a request into the user interface 470.

In some exemplary embodiments, requests can be implied without affirmative action of the subscriber 320. For example, and not limitation, the data aggregation system 300 can provide unprompted suggestions and recommendations based on the subscriber's current sales and pricing as compared to sales and pricing of a market in which the subscriber participates. In that case, a request can be implied by the subscriber's logging into the website 430, or by the subscriber's subscription to the data aggregation system 300. Such implied requests can be treated in the same or similar manners as express requests from the subscriber 320.

The substance of a request can take various forms. The request can comprise, for example, and not limitation, an instruction to update pricing for a particular product or family of products, a request to view upsell opportunities for a particular customer, a request for bid assistance, a request to view a comparison between the subscriber's prices for a product versus a market average, or many other requests, demands, or instructions relating to data stored on the server assembly 230 or on the subscriber's client computer 102.

At 520, the request can be transmitted from the subscriber's web client 124 at the client computer 102 to the server assembly 230. At 530, the data analysis system 410 can process the request by analyzing or comparing data according to the request. Performance of such analysis can result in production of a result set, at 540, representing a response to the subscriber's request. The result set can be transmitted back to the client computer 102 at 550, and presented to the subscriber 320 via the web client 102 at 560.

A form and presentation of the result set can depend on preferences of the subscriber and on the substance of the request. For example, if the subscriber 320 requests to compare the subscriber's price of Product X extended to Customer A to others' prices of Product X extended to similar customers, the result set could comprise a set of data points representing prices of Product X. For an additional example, if the subscriber 320 requests a price update, the result set can comprise data confirming the update or can comprise a set of related products for which a price update is recommended based on the requested update. The result set can be presented to the subscriber 320 in many formats, such as by displaying a representation of the result set in a chart, graph, or table.

Various scenarios are presented below to exemplify tasks that can be performed via the data aggregation system 300. One of skill in the art, however, will recognize that these scenarios are merely exemplary and do not limit the number or type of tasks that can be performed through the data aggregation system 300.

### 1. Scenario 1: Price Management

Through the user interface 470, a subscriber 320 can update a price of a product or group of products. Such an update can apply to the price of the product extended to a single customer, all customers, or to a set of customers, such as a peer group. By indicating the price update, the subscriber 320 implicitly requests that the data aggregation system 300 update its records regarding an applicable price of a product.

In response to the subscriber's request, the data aggregation system 300 can perform various tasks. The data aggregation system 300 can update one or more records of the price of the applicable product as stored on the server assembly 230. Additionally, the peer grouping module 450 and the SKU mapping module 460 can be utilized to provide notifications and recommendations for repricing strategies of the subscriber 320.

For example, if the subscriber 320 requests an update to the price of Product X extended to Customer A, the data analysis system 410 can utilize the peer grouping module 460 to identify customers in a peer group with Customer A. Accordingly, the data aggregation system 300 can notify the subscriber 320 that specific other customers of such peer group may also require a price update. Alternatively, the data aggregation system 300 can automatically update pricing for other customers in the peer group with Customer A.

Additionally, when a pricing update request is received, the SKU mapping module can identify products related to Product X. Accordingly, the data aggregation system 300 can notify the subscriber 320 that specific related other products may also require a price update. For example, if product families are generally on sale according to equivalent schedules, the subscriber 320 may be reminded to update pricing for all products in a family with Product X. Further, the data aggregation system 300 can suggest that complementary products be featured in a subscriber's stores or catalogs to reap a greater benefit from a price reduction of Product X. Alternatively, the data aggregation system 300 can automatically update pricing for products related to Product X.

### 2. Scenario 2: Bid Assistance

A subscriber 320 can request that the data aggregation system 300 provide bid assistance to the subscriber 320. Bid assistance can be useful when a subscriber 320 desires to secure business from a particular customer or set of customers. This can occur, for example, when the customer specifically requests a bid from the subscriber 320, or when the subscriber 320 proactively seeks to secure the customer's business.

To receive bid assistance, the subscriber 320 can submit a list of products, and can further submit prices and quantities associated with such products. The products, prices, and quantities can be stored and submitted in the form of a spreadsheet, text document, or many other file formats. The submitted data can represent a mix of products the customer desires to purchase or, alternatively, a mix of products the customer currently purchases from a dealer or dealers other than the subscriber 320. In submitting this data, the subscriber's goal can be to receive a list of products, prices, and optional quantities to offer the customer, such that the customer will benefit from conducting business with the subscriber 320.

When the data aggregation system 300 responds to a bid request, the data analysis system 410 can consider, without limitation, the following: standard prices of the requested products, cost of goods for the requested products, previous successful bids for similar bid requests and similar customers, and related products in the SKU mapping database. In responding to the request, the data aggregation system 300 can weigh a goal of providing a low price, which would be favorable to the customer, against a goal of producing high margins, which would be favorable to the subscriber.

The SKU mapping module 460 can be utilized in responding to bid requests. For example, the data analysis system 470 can identify relationships between the requested products and can substitute one or more requested products with related products in the SKU mapping database. If it is determined that one or more substitute products could result in a higher margin for the subscriber 320 or a lower price for the customer, such substitute products can be recommended to the subscriber 320 in place of requested products. Ideally, a requested product can be replaced by a product that is priced lower and yet result in a higher margin for the subscriber 320.

In producing a response to a bid assistance request, the peer grouping module 450 can be utilized to identify customers in a peer group with the requesting customer. After such customers are identified, previous successful bids and unsuccessful bids for such customers can be considered in determining a response to the bid request.

In the case of a bid assistance request, the result set can comprise a list of products, along with a price at which to offer the customer the combination of products in the list. The result set can be presented the subscriber 320 in various formats, such as through displaying a table to the subscriber 320 via the user interface 470 of the website 430.

An exemplary bid output screen is illustrated in FIG. 600. As shown in FIG. 600, the screen can consist of one or more sections for manipulating and displaying data. These sections can include, for example, an options section 610 and an output section 640.

The options section 610 can provide options for the subscriber to select how to determine a bid output. For example, with a mode selector 612, or match type selector, the subscriber can select a mode for determining which products to include in the bid output. Potential modes can include, without limitation, a “Closest Match” mode and a “Most Profitable” mode. The data aggregation system 300 can also provide one or more options or variables, through which the subscriber 320 can tweak the potential output.

In the “Most Profitable” setting, for example, the data aggregation system 300 can output a list of products designed to provide maximum profit to the subscriber 320. Such a mix of products can differ from the input list in that one or more output products can be substitutes for one or more input products. The SKU mapping module 460 can be utilized to determine possible substitutions. For example, and not limitation, it can be determined that a first output product can be substituted for a first input product when (1) the first output product is a substitute for the first input product, as determined by the SKU mapping module 460; and (2) the subscriber 320 can receive a greater margin on the first output product than it would receive on the first input product at the same price.

In contrast, in the “Closest Match” setting, products selected for the bid output can be selected such that they match, as closely as possible, the products input in the bid request. For example, if Product X is received as input in a bid assistance request, and if the requesting subscriber 320 sells Product X, then Product X can be provided as output in the suggested bid. Alternatively, if the subscriber 320 does not sell Product X, then Product X can be substituted for a product sold be the subscriber 320 that is most similar to Product X.

To assist in providing substitutions during bid assistance and other process of the data aggregation system 300, a database on the server assembly 230 of the data aggregation system 300 can store various product identifiers for each product of record on the server assembly 230. For example, suppose two subscribers sell Product X but provide different naming schemes, such that Product X has a different product identifier for each subscriber. The data aggregation system 300 can recognize that both product identifiers refer to Product X. Accordingly, when receiving a request for bid assistance, the data aggregation system can map product identifiers of input products to product identifiers of the subscriber 320.

The options section 610 can further comprise a price type selector 614 for allowing the subscriber 320 to select a pricing scheme for the bid output, and a mark-up indicator 616 for allowing the subscriber 320 to indicate a mark-up for the product in the bid output. As shown, the subscriber can select a “Best Price” price type, and can indicate, for example, a 33% mark-up in the mark-up indicator 616. Accordingly, the data aggregation system 300 will produce a bid output having prices set to a 33% mark-up over the subscriber's costs of providing the products. In other words, the bid output will provide the subscriber 320 with a 25% margin.

While in FIG. 600, selectors 612 and 614 are implemented as pull-down menus, this need not be the case. Selectors can be implements in many forms capable of enabling the subscriber to select one or more options from a predetermined list of options. For example, and not limitation, the selectors can comprise radio buttons or check boxes.

The output section 640 can comprise a table for displaying the bid output, preferably in an organized manner. One or more columns of the table can represent data inputted by the subscriber 320 in requesting bid assistance. In the table of FIG. 600, the first three columns repeat data input by the subscriber 320 and, accordingly, include the requested products and their associated prices and quantities. One or more of the remaining columns can represent data produced in response to the subscriber's request for bid assistance. For example a matched product column 642 can represent a product identifier, such as the subscriber's product identifier, for the corresponding input product or its selected substitute. A dealer cost column 644 can represent a cost to the dealer for providing the product identified by the product identifier. A proposed price column 646 can represent a proposed price for the bid. If a specific mark-up has been provided, such as in the mark-up indicator 616, then data in the proposed price column 646 can correspond to data in the dealer cost column 644 increased by the specified mark-up, as shown. A proposed quantity column 648 can represent a proposed quantity for the products in the bid. Such quantity need not be equivalent to the quantities entered by the subscriber 320 as input, as a substituted product can contain a different volume of product per packaged unit, thereby resulting in a different desired quantity of units. Columns of the table can further include columns representing the margin in dollars 650, margin in percentage 652, total selling price 654, difference from the customer's current selling price 656, or many other data.

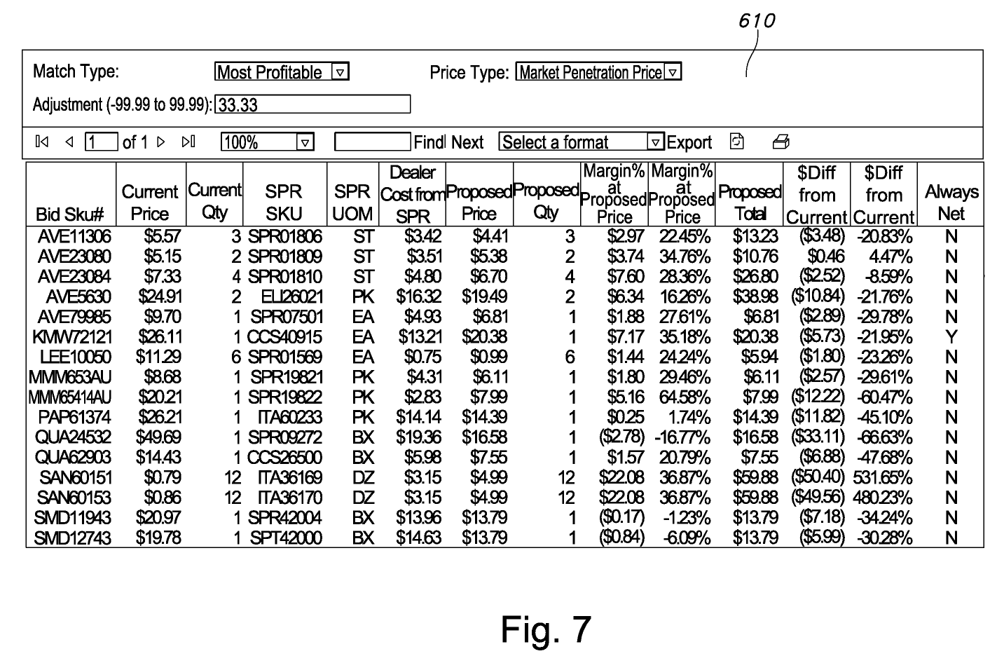

The bid output can alternatively be configured to provide varying margin percentages per product. For example, the subscriber 320 can request a bid having pricing designed to penetrate the market. For example, as shown in FIG. 7, the subscriber 320 can select a “Market Penetration Price” scheme in the price type selector 614. Such a selection can prompt the data aggregation system 300 to provide more aggressive pricing, which can be based on sales data received from multiple subscribers.

The bid output can be exported to a file for storage, manipulation, or viewing by the subscriber 320 or others. For example, the bid output can be exported to a spreadsheet format. Outside of the data aggregation system 300, the subscriber 320 or another party can then open the spreadsheet and tweak aspects of the bid output to fit the subscriber's needs.

### 3. Scenario 3: Customer Management

The subscriber 320 can submit a request to manage a particular customer. In response, the data analysis system 410 of the data aggregation system 300 can compare and analyze data relating to the selected customer. The result set can comprise one or more recommendations, suggestions, or observations regarding the selected customer.

For example, if the subscriber requests to manage Customer A, the data analysis system 410 can consider sales data relating to Customer A as well as sales data relating to other customers in a peer group with Customer A. The data analysis system 410 can compare the subscriber's sales to Customer A versus other subscribers' sales to the peer group. This comparison can illustrate, for example, the following: the subscriber is priced adequately, too low, or too high for Customer A based on other sales in the market; the subscriber should be able to sell a greater volume of certain products to Customer A; or customers similar to Customer A usually purchase a certain identified set of products and, therefore, the subscriber should attempt to sell these identified products to Customer A in quantities similar to those usually purchased by customers similar to Customer A.

The SKU mapping module 460 can be utilized in customer management to identify products that can be substituted for those currently sold to the selected customer. Substitutions can be recommended to increase the subscriber's margins, to lower prices extended to the customer, or for various combinations of reasons directly or indirectly resulting in increased revenues for the subscriber 320 or the website manager 420.

Accordingly, through the data aggregation system 300, pricing and other elements of sales strategies can be managed for individual customers of groups of customers.

### 4. Scenario 4: Scorecard

In an additional example, the subscriber 320 can, expressly or implicitly, request to view a scorecard regarding the subscriber's sales. A scorecard can comprise a snapshot of the subscriber's sales, and can comprise various combinations of data. For example, and not limitation, the scorecard can compare the subscriber 320 to other subscribers 320 in similar markets, or can illustrate statistics regarding the subscriber's sales.

When a scorecard is requested, the data aggregation system 300 can perform various combinations of comparisons and analyses. A set of comparisons and analyses performed can be predetermined in many manners. For example, such set can be determined by user preference or by default settings. The result set can comprise the scorecard, a set of data illustrating a status or position of the subscriber based on analyses performed. Such result set can be presented to the subscriber, preferably via the user interface 470.

### 5. Scenario 5: Profitability Analysis

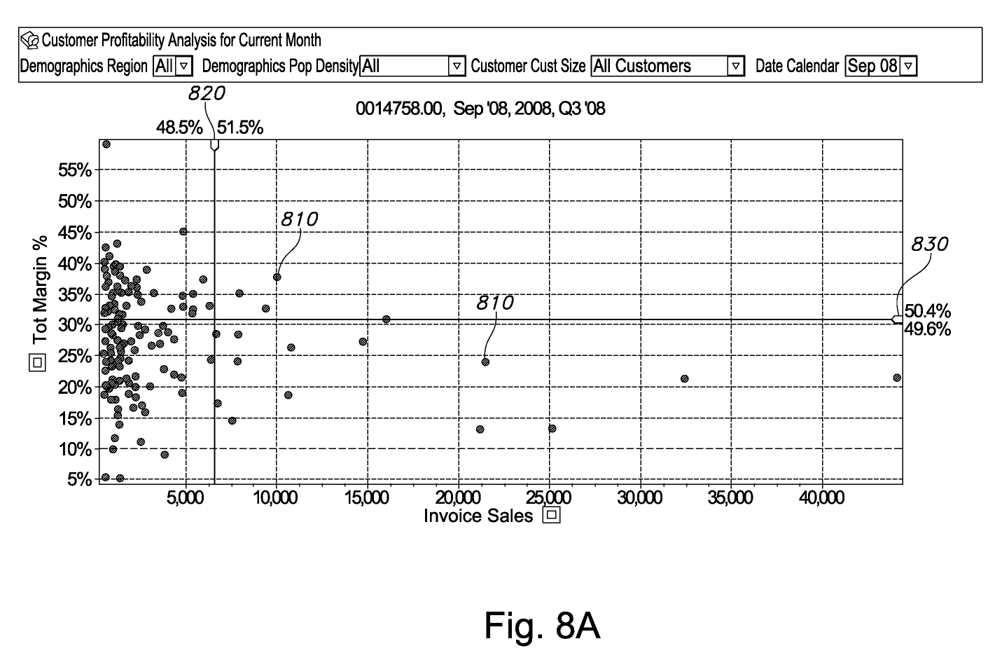

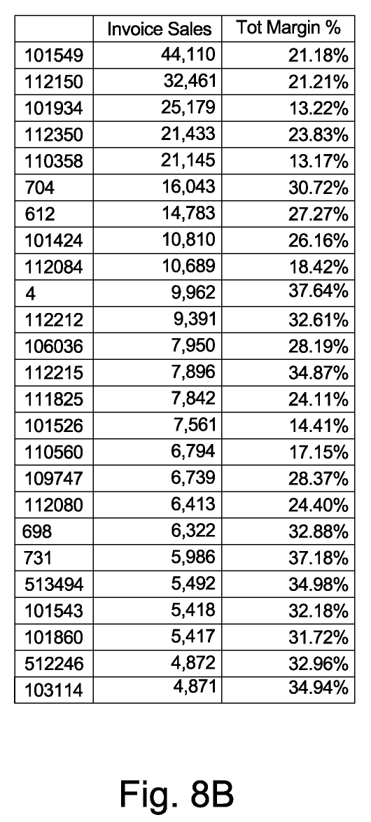

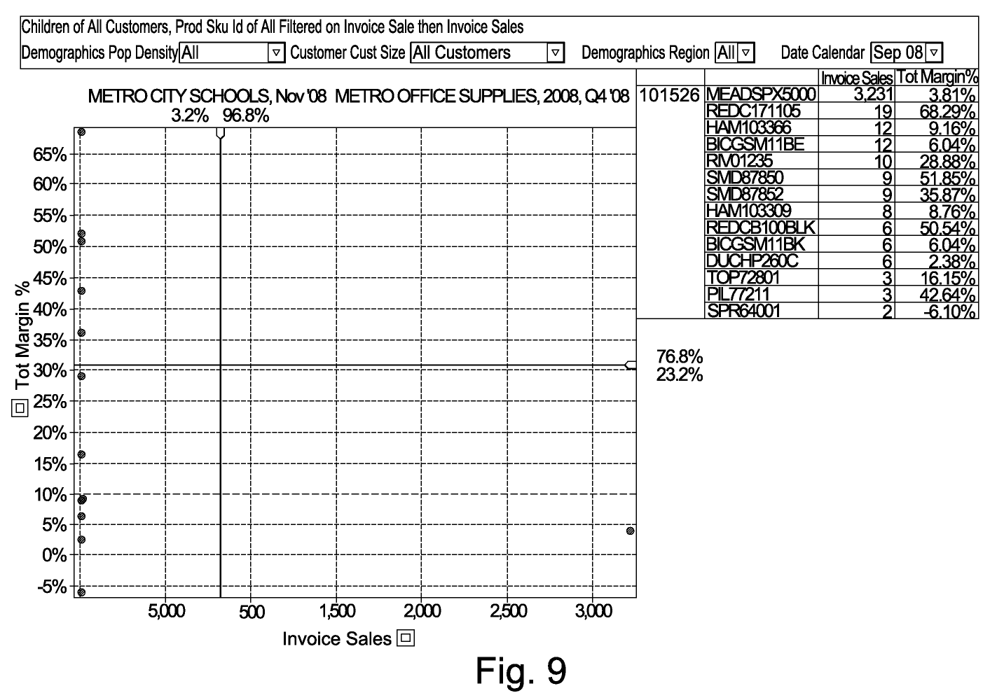

A subscriber 320 can desire to analyze profitability of one or more of its customers, and the data aggregation system can provide tools for such analysis. FIGS. 8A-8B illustrate exemplary outputs via the website 430 in response to a request for profitability analysis.

As shown in FIG. 8A, the data aggregation system 300 can output a scatter plot to represent profitability of the subscriber 320. In the plot of FIG. 8A, each point 810 can represent a customer of the subscriber 320. Additionally, the x-axis can represent total sales to a customer, and the y-axis can represent the total margin percentage of products sold to a customer.

Moveable dividers 820 and 830 can be used to group customers based on where each customer falls within a range of values on the x-axis and y-axis. The moveable dividers 820 and 830 can be utilized to create quadrants in the scatter plot. The top-left quadrant can include customers having relatively low invoice totals and relatively high total margins with the subscriber 320. The top-right quadrant can include customers having relatively high invoice totals and relatively high margins with the subscriber 320. The bottom-left quadrant can include customers having relatively low invoice sales and relatively low margins with the subscriber 320. Finally, the bottom-right quadrant can include customers having relative high invoice sales and relatively low margins with the subscriber 320.

The data aggregation system 300 can further output text data corresponding to data displayed in the plot. Such data can be arranged in table format as shown in FIG. 8B, where each point of the plot in FIG. 8A corresponds to a row in the table of FIG. 8B.

The subscriber 320 can investigate each customer further to determine causes of total margins of one or more customers. This further investigation can be initiated by many means. For example, and not limitation, the subscriber 320 can right click a point 810 in the plot or a row in the table. The subscriber 320 can then be presented with a menu, and, from the menu, the subscriber 320 can select an option to further investigate the customer associated with the selected point or row.

FIG. 9 illustrates an output of the data aggregation system 300 in response to such a selection to further investigate a particular customer. The output can include another scatter plot and another table. In this case, however, each point in the plot and each row in the table can correspond to a product sold to the selected customer of the subscriber 320. Each point and row can illustrate total invoice sales and margin of sales of a particular product to the selected customer.

### 6. Scenario 6: Customer Strategy Analysis

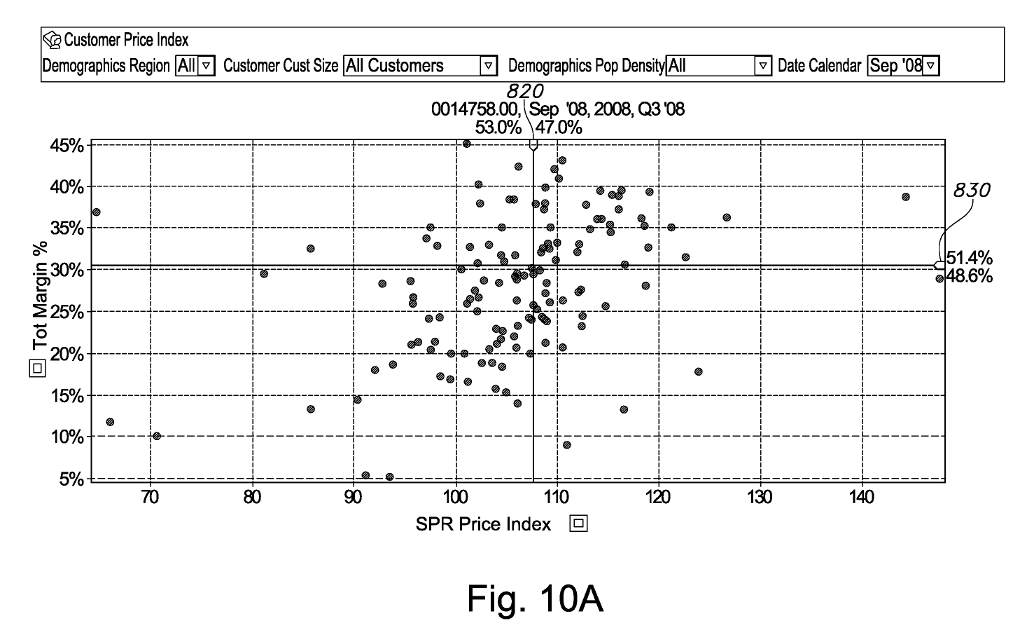

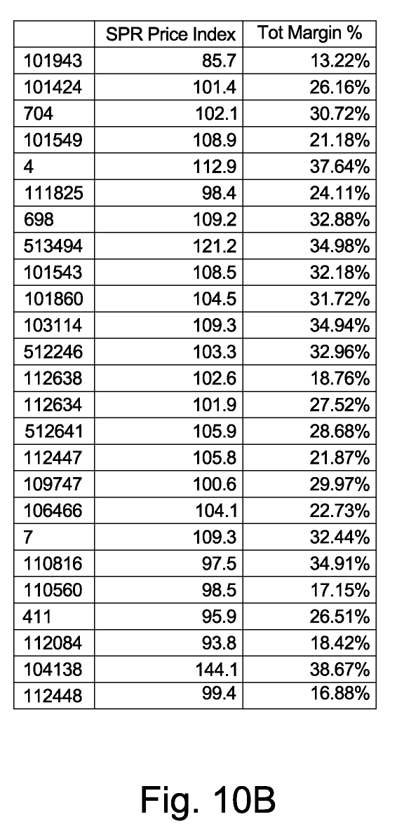

A subscriber 320 can utilize the data aggregation system 300 to analyze the subscriber's sales strategies for one or more customers. In response to a request to perform such analysis, the data aggregation system can output data such as that illustrated in FIGS. 10A-B.

As shown, output for sales strategy analysis can include a scatter plot, as shown in FIG. 10A, and a table, as shown FIG. 10B. Each point in the plot and each row in the table can correspond to a customer of the subscriber 320. The x-axis can represent average price index for customers, and the y-axis can represent total margin of sales to customers. An average price index of X for a customer can indicate that, in an average sale to the customer, the subscriber 320 sells products to the customer at X percent of the market average of sales of such products. For example, an average price index of 100 can indicate that, in an average sale to the customer, the customer purchases products from the subscriber 320 at average market prices. The market average, which can be used in determining an average price index for each customer, can be determined from the aggregated data stored on the server assembly 230.

As described above, moveable dividers 820 and 830 can separate the plot into quadrants. In the plot of FIG. 10A, the top-left quadrant can include customers with relatively low price index and relatively high margin. While these customers tend to purchase products from the subscriber 320 at low prices, these customers also provide high margins for the subscriber 320. The top-right quadrant can include customers having relatively high price indexes and relatively high margins. These customers can indicate retention risks, as they can likely find lower prices elsewhere. Given the high margins currently received from these customers, the subscriber may be able to lower their prices to retain these customers. The bottom-left quadrant can include customers having relatively low price indexes and relatively low margins. These customers appear to be receiving good deals from the subscriber 320 but, unfortunately, the subscriber is receiving low margins from them. Accordingly, the subscriber 320 may want to consider increasing prices extended to these customers. Finally, the bottom-right quadrant can include customers having relatively high price indexes and relatively low margins. Although the margins provided by these customers are relatively low, it may be a bad idea to increase prices extended to these customers, as they can likely already find lower prices elsewhere.

### 7. Scenario 7: Market Comparison

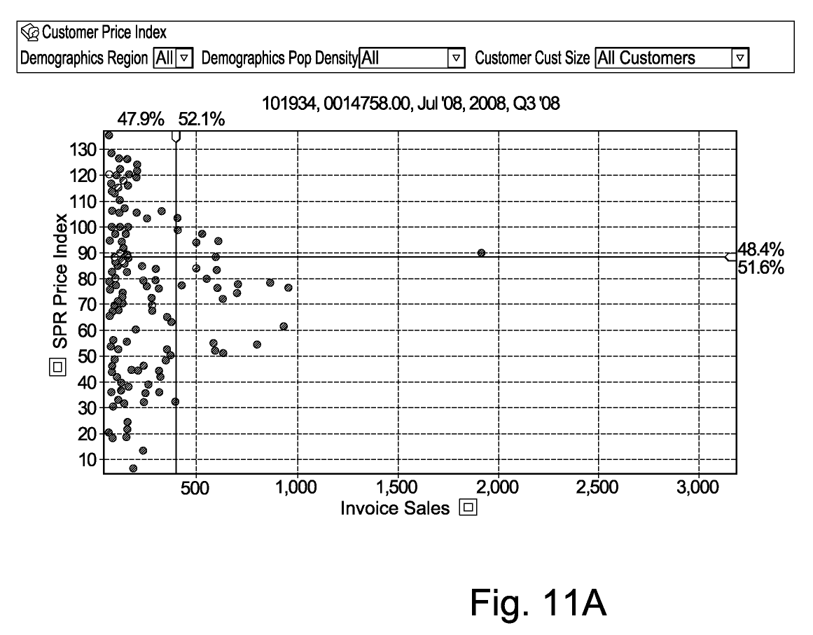

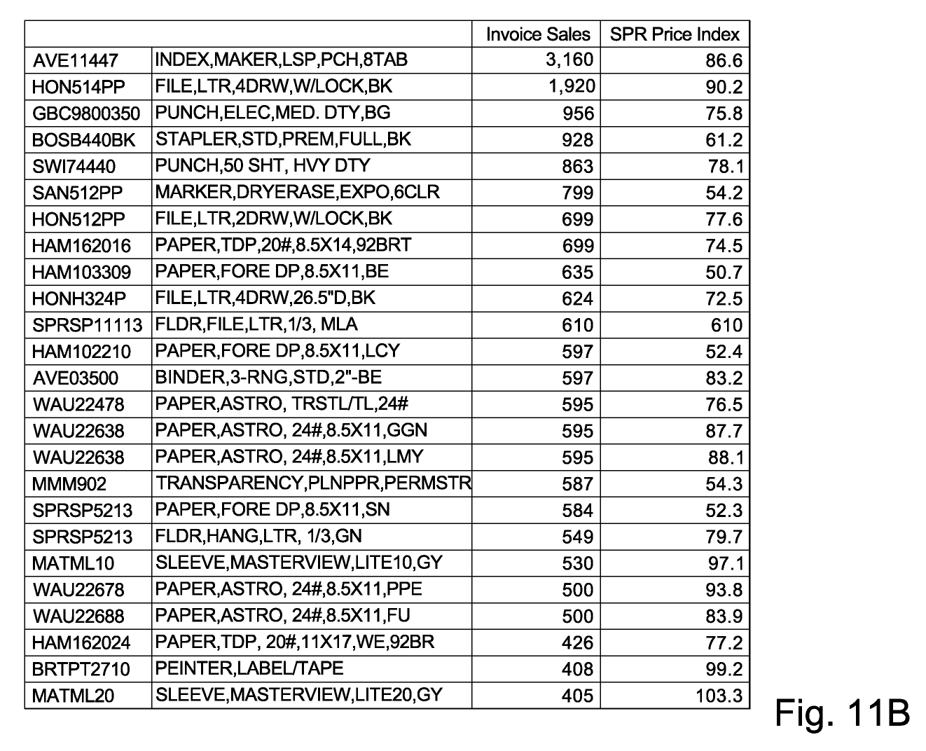

FIGS. 11A-B illustrate exemplary output of the data aggregation system 300 in response to a subscriber's request to compare the subscriber's pricing to market pricing. Each point in the scatter plot of FIG. 11A and each row in the table of FIG. 11B can represent a product sold by the subscriber 320. The x-axis of the table can represent total sales of each product, and the y-axis can represent average price index of sales of each product. For example, if the average price index of a product is X, then, in an average sale of the product by the subscriber 320, the product is sold at X percent of the market average.

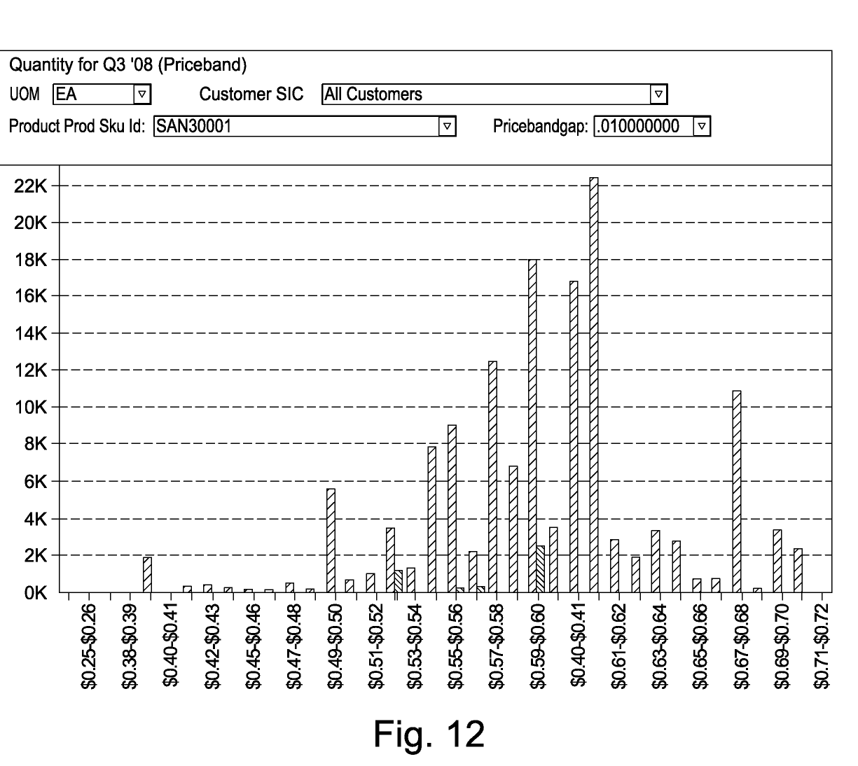

Alternatively, instead of displaying a scatter plot, the data aggregation system 300 can display a bar chart for comparing the subscriber's pricing to market pricing. For example, in the chart depicted in FIG. 12, each bar can represent total sales of a selected product in a particular price range. The price range for each bar can be indicated below each bar, as shown. In each price range a first bar 1210 can indicate sales in the market as a whole, and a second bar 1220 can indicate sales of the subscriber 320. As a result, the subscriber 320 can determine whether the subscriber's sales are in accordance with sale prices of the market as a whole.

Accordingly, the data aggregation system 300 can be utilized to compare a subscriber's pricing to market pricing, thereby enabling the subscriber 320 to adjust its pricing accordingly.

### 8. Scenario 8: Trend Analysis

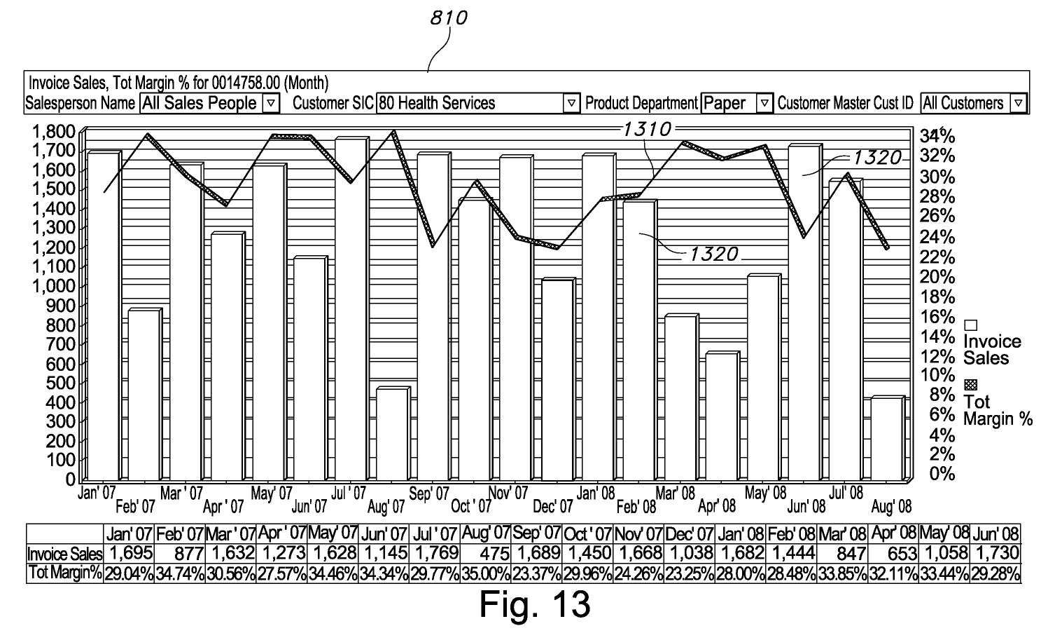

A subscriber 320 may desire to view trends of sales of a particular product or group of products, and the data aggregation system 300 can display such trends to the subscriber 320. As illustrated in FIG. 13, the data aggregation system 300 can display a chart illustrating sales of selected products during specified time periods. Accordingly, the subscriber 320 can observe how sales of such products change over a period of time.

In FIG. 13, a margin line 1310 can represent total margin of sales of the selected products in a specified time period. Additionally, each bar 1320 can represent invoice sales for the specified time period, which time period can be indicated below each bar 1320. Using this data, the subscriber 320 can determine whether to stock the products in question and, if applicable, how much of such products to stock. The subscriber 320 can also determine which products are popular in certain time periods and, as a result, the subscriber 320 can determine sales strategies based on this knowledge.

### 9. Scenario 9: Portfolio Gap Analysis

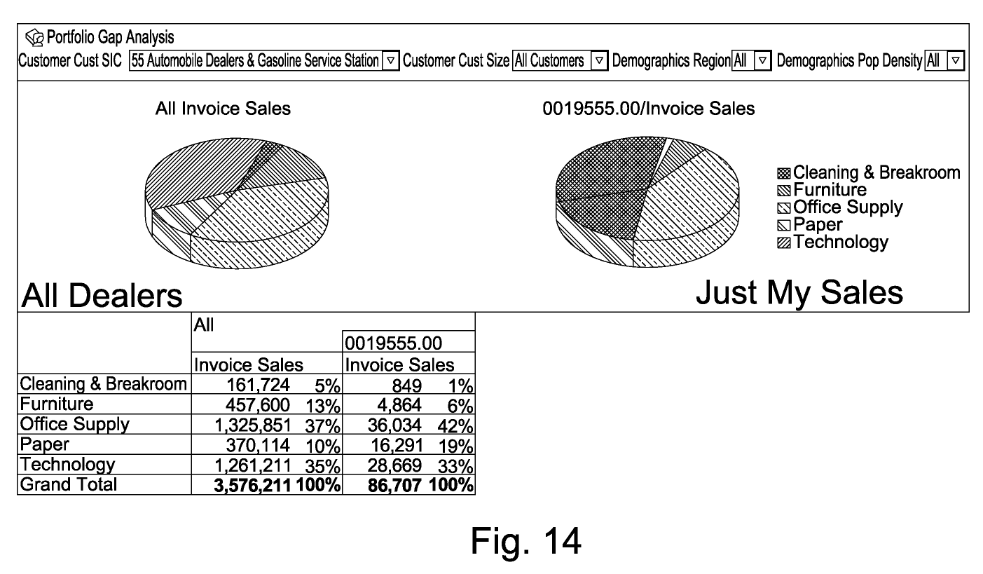

A subscriber 320 can request to compare a mix of products it sells to a group of one or more customers to a mix of products sold to similar customers by the general market. In response to such a request, the data aggregation system 300 can output data, such as that depicted in the charts of FIG. 14.

FIG. 14 illustrates a first chart 1410, which can represent a mix of products sold to the customers by the market, and a second chart 1420, which can represent a mix of products sold to the same customers by the subscriber. A table 1430 can mirror data displayed in the charts to allow a text comparison of such data.

This data can enable the customer to determine a standard mix of products for the selected customers. Accordingly, the subscriber 320 can tailor its sales strategies to sell products generally purchased by these customers.

### Additional Output Displays

Accordingly, as described in the above scenarios, a subscriber 340 can view result sets relating to the subscriber's current pricing and sales strategies. Tables, charts, and graphs representing result sets can be customizable by the subscriber and can include, for example, the following: waterfalls illustrating net pricing, costs, and standard pricing; histograms and grids illustrating effects of price changes or hypothetical price changes; and scatter plots illustrating a range of pricing for a product or family of products.

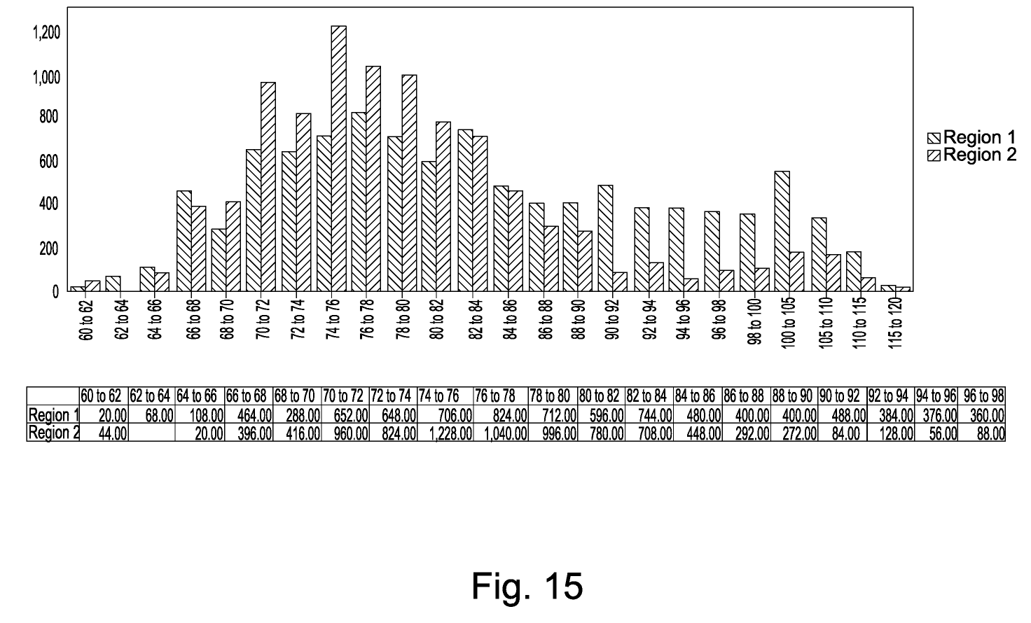

FIGS. 15-22 illustrate additional examples of tables, charts, and graphs representing result sets and displayable to subscribers 420 via the user interface 470. One skilled in the art will recognize that the charts and graphs of FIGS. 15-22 are illustrative and not restrictive. Many types of charts and graphs, illustrating many categories of data, can be displayed to subscribers 320.

FIG. 15 illustrates a price band analysis. When displaying FIG. 15, or a similar chart, the data aggregation system 300 can provide the subscriber a snapshot of market pricing for a particular product. In FIG. 15, the Y-axis represents a quantity units sold at each price point. In this example, two sales territories are compared. As shown, Region 1 sells more of the product between prices of 90 and 100. This can suggest that sales training may be useful in Region 2.

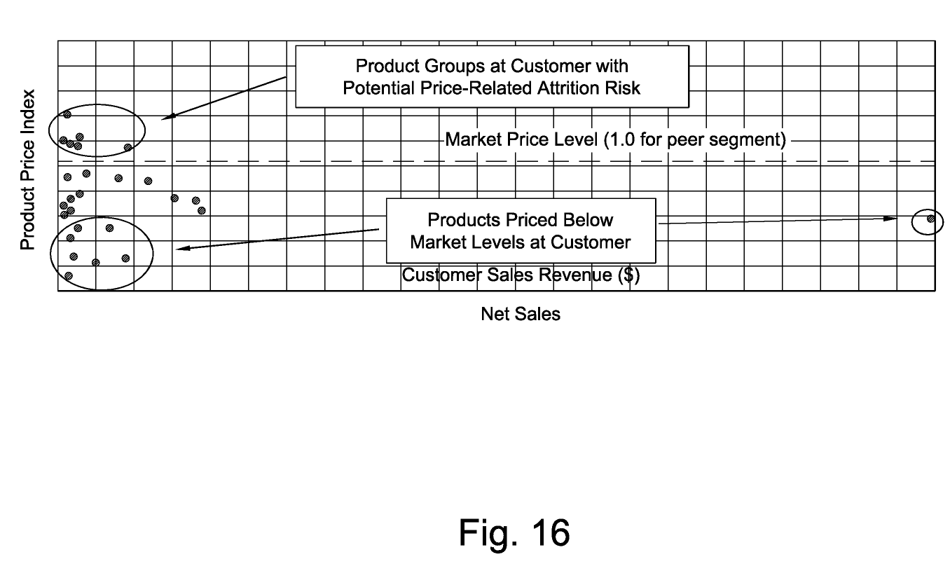

To illustrate relative market price points for multiple products, or for one or more group of products, the data aggregations system 300 can display a scatter plot, such as that of FIG. 16. FIG. 16 illustrates a scatter plot view of an exemplary customer of a subscriber 320. In the plot, each dot represents a product or a group of products. This plot can be useful for helping the subscriber 320 understand its pricing for the customer as compared to the market in general. The market price level shows the average price for this type of customer, so that one can view how existing price points for this customer compare to the market. For example, the dot on the far right side represents copy paper priced below market. If this dot represents a new customer, the pricing may be part of a strategy to acquire the customer. However, if the customer has done business with the subscriber for a significant duration, the plot displays a price increase opportunity.

The plot of FIG. 16 can be filtered to compare the subject customer to customers of a specific SIC code, geography, or size. Once the subscriber 320 ascertains the relative position of each product or group of products in the market, the subscriber can then determine priorities for price modifications.

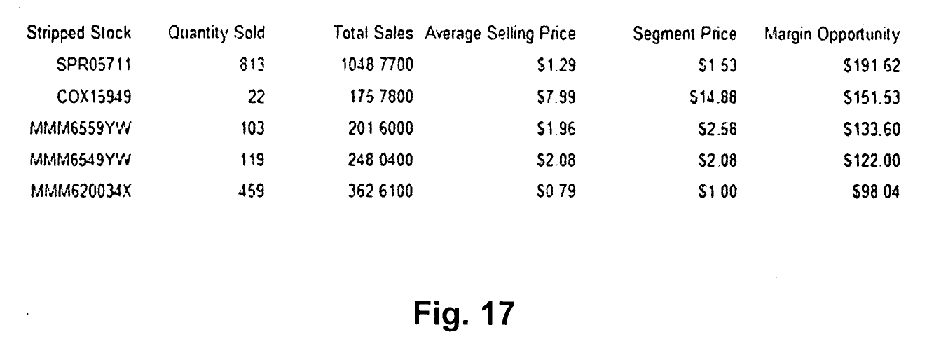

FIG. 17 illustrates a chart depicting top margin opportunities for a certain customer or sales territory. In this case, the customer pays $1.29 for SPARCO® view binders, while the average price is $1.53. If the subscriber 320 can sell the binders to the customer for the average price, the subscriber would profit an additional $191.62 in margin. On the other hand, according to the chart, the subscriber 320 sold a total of 813 binders, a significant quantity. Accordingly, the subscriber 320 may be willing to maintain the low price to retain high sales volume from the customer.

The following line of the chart, however, displays a record of an item averaging $14.88, while the subscriber 320 sells the item for only $7.99. After viewing this chart, the subscriber 320 may decide to raise the price of this item.

Accordingly, this view can be used to identify price increase opportunities for a specific customer, sales territory, or for the subscriber's entire business.

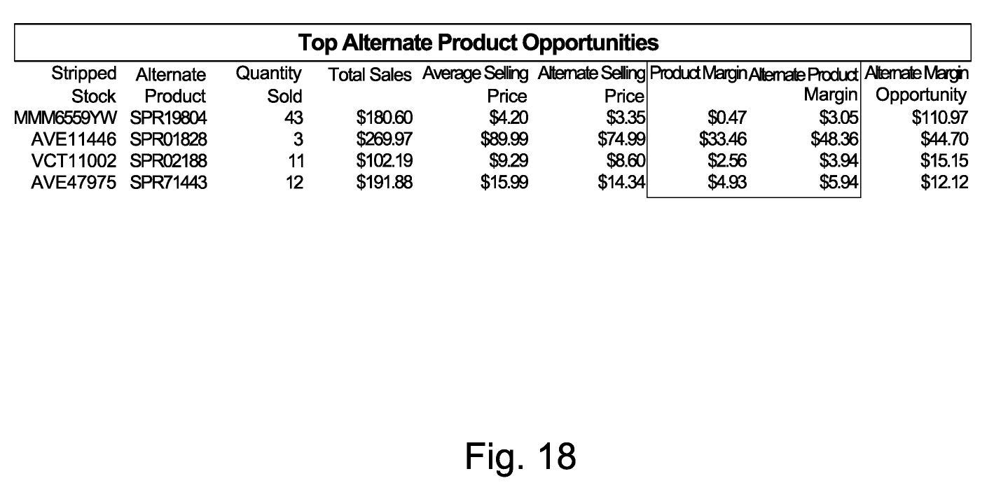

FIG. 18 illustrates a chart resulting from applying the SKU mapping module 460 to identify potential substitute products. As shown, the chart of FIG. 18 illustrates opportunities for the subscriber 320 to improve its margins by displaying substitution options for a particular customer. As shown in the second line of the chart, the customer purchased three boxes of the Avel 1446 for $89.99, but could have purchased a SPARCO® equivalent, SPR1828, for $74.99 to result in a higher margin for the subscriber and a lower price for the customer.

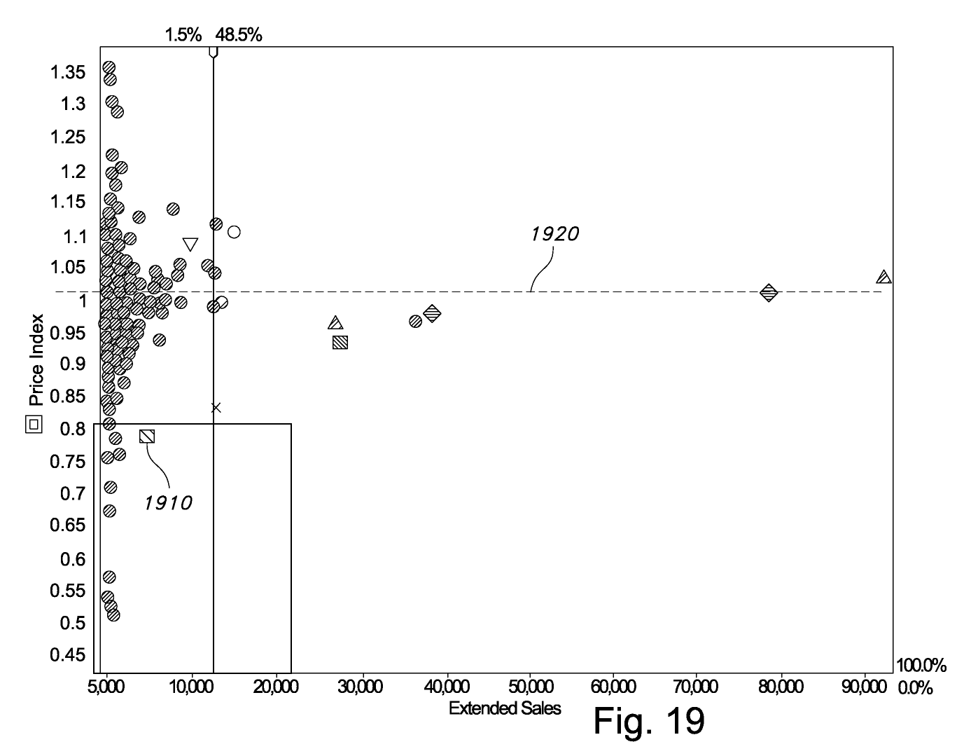

FIG. 19 illustrates a graph depicting a high-level view of a plurality of a subscriber's customers. This graph shows the relative price positions, thereby enabling that the subscriber 320 to identify customers that are inappropriately priced. For example, at 1910, the graph illustrates an insurance agent purchasing $5000 of product per month. For the insurance agent, the product is priced 21% below an average market price, which is indicated at line 1920. When displayed to the subscriber 320, this graph can suggest a price increase for the insurance agent.

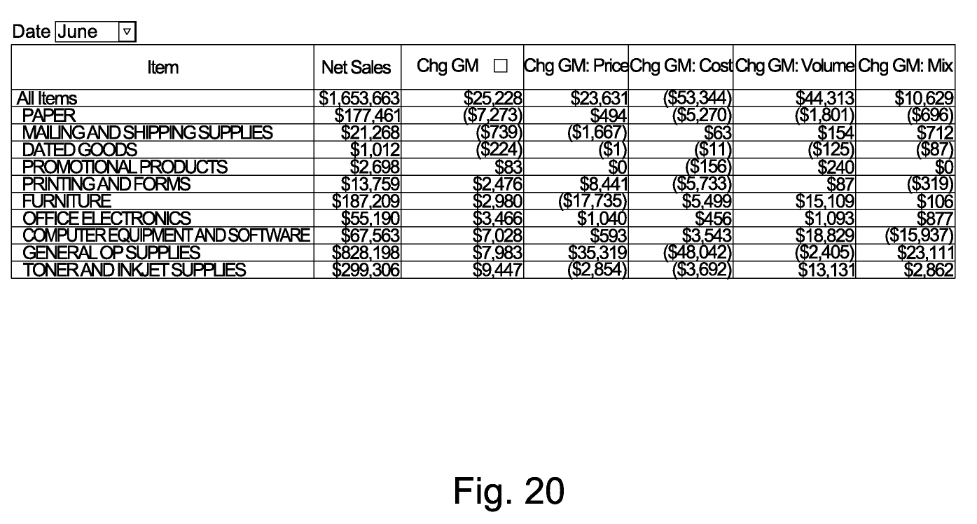

FIG. 20 illustrates an analysis report depicting gross profits. A report similar to that of FIG. 20 can assist a subscriber 320 in determining which products and customers are driving margins in the subscriber's business. The report can pinpoint margin issues that cause margin erosion

In FIG. 20, a chart illustrates that paper sales are $177,461 this month and that margins are down $7,273 from the previous period. The chart further indicates that margins are up $494 because the subscriber 320 is selling paper for a higher price than in the previous period, but that cost have shifted unfavorably by $5270. In other words, the subscriber 320 had a price increase that the subscriber 320 did not pass on to the customer. In addition, subscriber's margin is down $1801 due to decreased sales volume, and the product mix (i.e., combination of sold products) shifted unfavorably by $696, indicating that customers are buying a less profitable mix of paper.

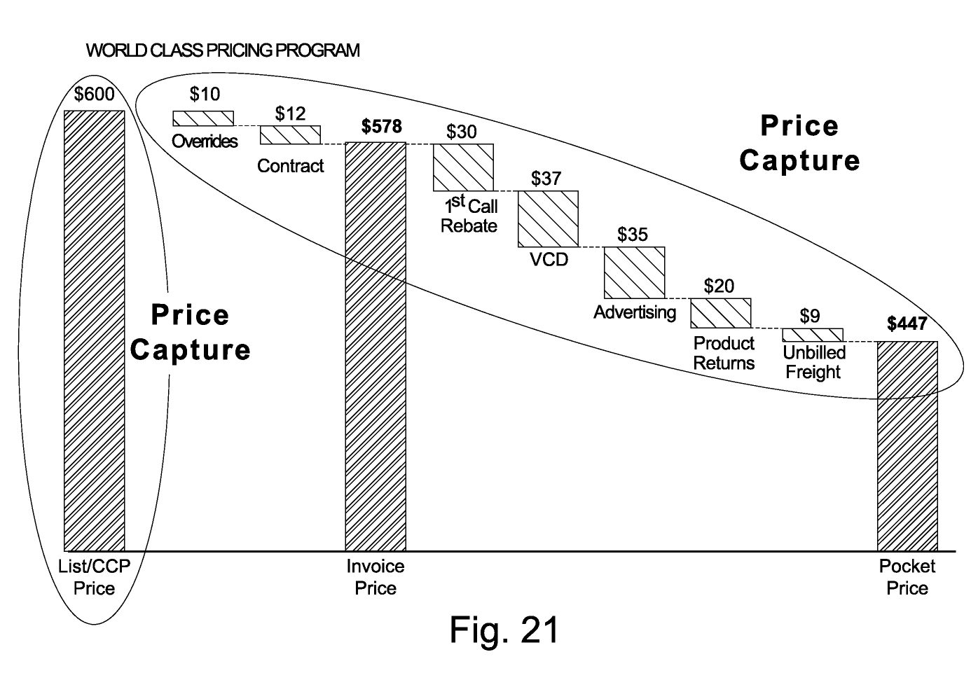

FIG. 21 illustrates a price waterfall. Utilizing the subscriber's sales data, the subscriber 320 can evaluate potential profit leakages, including cost to serve, inventory holding costs, and rebates within their customers to identify profitable customers.

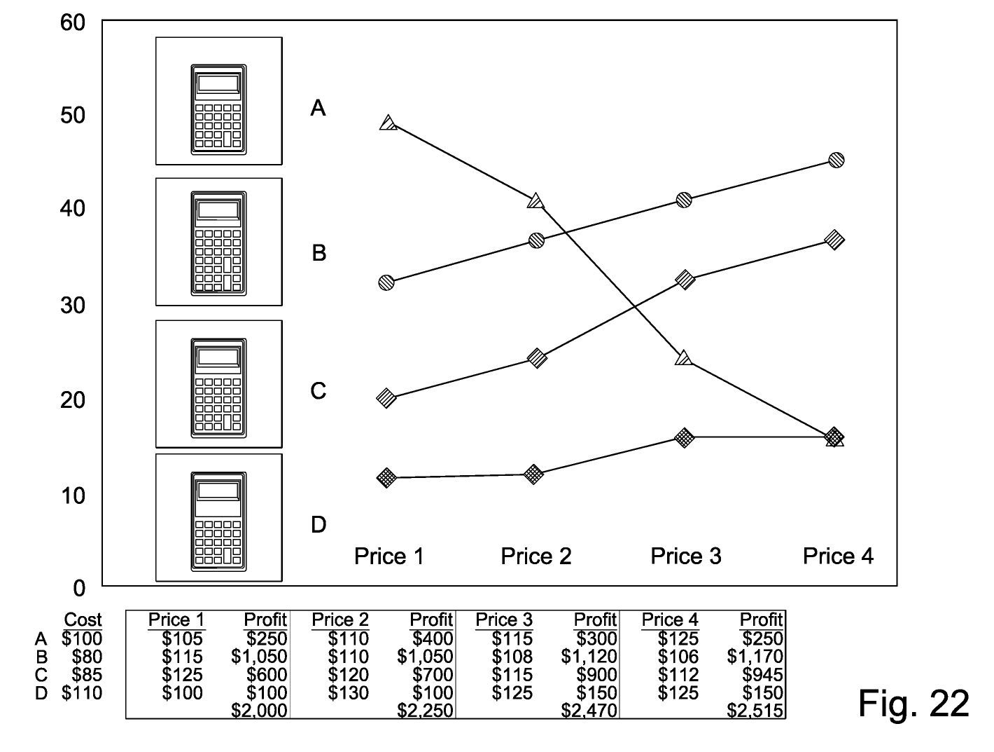

FIG. 22 illustrates a graph and chart depicting use of the SKU mapping module 460 to determine a profitable combination of product to sell to a particular customer. In the graph of FIG. 11, the price and margin of calculators illustrate that Product X has a 50% market share but very low profit. By increasing the price of Product X and decreasing prices of Products B and C, the subscriber 320 can drive sales to the more profitable products, B and C. In this example, the subscriber 320 can raise profits on calculators by 25% by selling the same number of units.

Accordingly, as described and illustrated herein, the data aggregation system 300 can receive, aggregate, and analyze data from multiple subscribers.

While the data aggregation system 300 has been disclosed in exemplary forms, it will be apparent to those skilled in the art that many modifications, additions, and deletions may be made without departing from the spirit and scope of the system, method, and their equivalents, as set forth in the following claims.

1. A data aggregation system comprising:
a receipt system for receiving sales data from a plurality of subscribers and aggregating the sales data together, the sales data representing sales associated with the plurality of subscribers, wherein a first subscriber and a second subscriber of the plurality of subscribers are distinct entities independent of each other;
a server assembly for storing the aggregated sales data;
a user interface for the first subscriber of the plurality of subscribers to pose a request to the server assembly; and
a data analysis system for processing at least a portion of the aggregated sales data based on the request posed by the first subscriber.

2. The data aggregation system of claim 1, wherein the first subscriber and the second subscriber are competitors of each another.

3. The data aggregation system of claim 1, the data analysis system comparing sales data of two or more of the plurality of subscribers.

4. The data aggregation system of claim 1, wherein the sales data comprises data relating to individual sales of the plurality of subscribers.

5. The data aggregation system of claim 1, wherein the sales data comprises pricing lists for one or more products of the plurality of subscribers.

6. The data aggregation system of claim 1, further comprising a peer grouping module for grouping customers of the subscribers in peer groups based on similarities among the customers.

7. The data aggregation system of claim 6, wherein the at least a portion of the aggregated sales data processed comprises sales data relating to customers in one or more select peer groups.

8. The data aggregation system of claim 1, further comprising a mapping database for storing relationships between one or more products offered for sale by the plurality of subscribers.

9. The data aggregation system of claim 8, wherein the mapping database indicates that a first product is a substitute for a second product.

10. The data aggregation system of claim 8, wherein the mapping database indicates that a first product complements a second product.

11. The data aggregation system of claim 8, wherein the mapping database indicates that a first product and a second product belong to a same family.

12. A data aggregation method comprising:
receiving a first set of sales data from a first subscriber, the first set of sales data comprising data relating to one or more sales associated with the first subscriber;
receiving a plurality of additional sets of sales data from a plurality of additional subscribers;
determining a result set of data based on at least a portion of the first set of sales data and at least a portion of the additional sets of sales data; and
presenting the result set to the first subscriber.

13. The data aggregation method of claim 12, wherein presenting the result set to the first subscriber comprises presenting a comparison of sales of the first subscriber to sales of one or more of the additional subscribers.

14. The data aggregation method of claim 12, wherein presenting the result set to the first subscriber comprises presenting a comparison of a mix of products sold by the first subscriber to a mix of products sold by one or more of the additional subscribers.

15. The data aggregation method of claim 12, wherein the first subscriber is independent of one or more of the additional subscribers.

16. The data aggregation method of claim 12, further comprising receiving sets of sales data from the first subscriber on a periodic basis.

17. The data aggregation method of claim 12, the first set comprising details relating to individual sales associated with the first subscriber.

18. The data aggregation method of claim 12, wherein presenting the result set to the first subscriber comprises displaying a representation of the result set to the first subscriber via a web client.

19. The data aggregation method of claim 12, wherein presenting the result set to the first subscriber comprises displaying a chart or graph to the first subscriber.

20. The data aggregation method of claim 12, further comprising providing a database mapping relationships between products sold by one or more of the additional subscribers and the first subscriber.

21. The data aggregation method of claim 20, the database indicating that a first product is a substitute for the second product.

22. The data aggregation method of claim 20, wherein determining the result set comprises utilizing data in the database to recommend that a second product be substituted for a first product in sales associated with the first subscriber.

23. The data aggregation method of claim 12, wherein determining the result set comprises comparing the first set to the additional sets.

24. The data aggregation method of claim 12, further comprising selecting one or more customers of the first subscriber and the additional subscribers for membership in a peer group, wherein members of the peer group are similar according to a predetermined formula.

25. The data aggregation method of claim 24, wherein determining the result set comprises determining a standard combination of products for a member of the peer group based at least partially on data relating to sales made to other members of the peer group.

26. The data aggregation method of claim 24, wherein determining the result set comprises comparing a portion of the first set regarding sales to members of the peer group to a portion of the additional sets regarding sales to members of the peer group.

27. The data aggregation method of claim 12, wherein determining the result set of data comprises determining a repricing strategy for a product of the first subscriber.

28. The data aggregation method of claim 27, wherein the alternate sales strategy comprises a price modification for the first product.

29. A data aggregation method comprising:
receiving bid data from a first subscriber, the bid data comprising a first product list of one or more products;
providing a second product list of one or more products and data associated with the products in the second product list;
determining a recommended bid response, the bid response comprising a list of one or more products and a pricing strategy based at least partially on a comparison of the first product list to the second product list; and
presenting the recommended bid response to the first subscriber.

30. The data aggregation method of claim 29, wherein determining a recommended bid response comprises substituting a first product in the first product list with a second product in the second product list.

31. The data aggregation method of claim 29, further comprising receiving a selection of a mode of responding to the bid data.

32. The data aggregation method of claim 29, further comprising receiving sales data relating to past sales of one or more products in the first product list, wherein determining a recommended bid response comprises analyzing the sales data.

33. The data aggregation method of claim 29, further comprising:
receiving customer data regarding a customer associated with the bid data; and
identifying a peer group for the customer, the peer group having predetermined similarities to the customer.

34. The data aggregation method of claim 33, further comprising receiving sales data relating to past sales of one or more members of the peer group, wherein determining a recommended bid response comprises analyzing the sales data.

35. A data aggregation method comprising:
providing a product list of products and associated prices of the products;
providing a database for storing relationships between different products in the product list, the database indicating a predefined relationship between at least a first product and a second product in the product list;
providing updated pricing for the first product;
automatically identifying the second product based on the predefined relationship between the first product and the second product; and
performing an action relating to the second product.

36. The data aggregation method of claim 35, wherein performing the action relating to the second product comprises automatically updating a price of the second product.

37. The data aggregation method of claim 35, wherein performing the action relating to the second product comprises notifying a user of the relationship between the first product and the second product.

38. The data aggregation method of claim 35, wherein providing updated pricing for the first product comprises receiving updated pricing directly from a user.

39. The data aggregation method of claim 35, further comprising receiving sales data relating to past sales of the first product, wherein providing updated pricing for the first product comprises analyzing the past sales data and adjusting prices based at least partially on the past sales data.
